(19) United States
(12) Patent Application Publication
(10) Pub. No.: US 2012/0323656 A1
(43) Pub. Date: Dec. 20, 2012

(54) PERSONALIZED PURCHASE OFFERS BASED ON ITEM-LEVEL TRANSACTION DATA FROM MULTIPLE SOURCES

(75) Inventor: Bryan W. Leach, Denver, CO (US)

(73) Assignee: Ibotta, Inc., Denver, CO (US)

(21) Appl. No.: 13/527,395

(22) Filed: Jun. 19, 2012

Related U.S. Application Data
(60) Provisional application No. 61/498,703, filed on Jun. 20, 2011.

(51) Int. Cl. G06Q 30/02

(52) U.S. Cl. 705/14.17; 705/14.53; 705/14.1; 705/14.23

(57) ABSTRACT

Example systems and methods of generating and providing personalized purchase offers based on item-level purchase data are presented. In one example, item-level purchase data from multiple sources for each of a plurality of users are aggregated. Offer data are received from offer providers. At least one user is selected to receive an offer targeted to the at least user based on the item-level purchase data and the offer data. The offer is transmitted to a communication device of the at least one user.

### RELATED APPLICATIONS

This application claims the benefit of priority of U.S. Provisional Application No. 61/498,703, entitled “A SYSTEM AND METHOD FOR COLLECTING, STORING AND UTILIZING PURCHASING DATA,” and filed Jun. 20, 2011, which is hereby incorporated herein by reference in its entirety.

### BACKGROUND

For many years, sales-oriented businesses, such as manufacturing and retail businesses, have employed many different methods for increasing sales volume. One often-used type of effort for increasing sales is the distribution of coupons and similar purchase offers, which typically provide consumers the opportunity to purchase a product or service at a reduced cost for some predefined period of time. Such offers may be provided by both manufacturers and retailers. Similarly, a retail establishment, such as a grocery store, may provide an in-store special, such as a “buy one, get one free” offer, on one or more individual products. Oftentimes, such offers are provided to all potential customers of the retail outlet. In other cases, the customer may be required to join a loyalty program associated with the retailer (alternatively, a “merchant”) to receive offers that are restricted to members of the program.

As an increasing volume of retail activity is carried out online via the Internet, the ability to provide special offers to current customers of a retail business is enhanced due to a greater ability to identify the customer and the products purchased by that customer. For example, since a customer often provides personal information, including contact information in the form of an email address or the like, to a retailer when purchasing a product from an online retailer, the online retailer may retain records of the items a specific customer has purchased and direct specific purchase incentives to its customers at any time. In some cases, the online retailer may also keep track of the various products the customer has viewed, investigated, or purchased on the website of the online retailer. Such information may be placed in a digital “cookie” stored in the computer of the online customer and subsequently accessed by the online retailer. Based on the particular products a customer has viewed and/or purchased at the website of the retailer, the retailer may then provide incentives or offers of particular interest to specific customers.

More recently, some bricks-and-mortar retailers have begun to provide offers specifically targeted to certain customers. For instance, some of these retailers generate coupons at the point-of-sale based in part on the items that are currently being purchased. As a result, like the online retailers, these offline retailers may provide at least some offers that are directed to specific customers based on past purchases made by the customer from the retailer.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example system having a client-server architecture for a server platform capable of employing at least some of the systems and methods described herein;

FIGS. 2A, 2B, and 2C present a block diagram of an example transaction and offer system including modules and data storage employable in the server platform of FIG. 1;

FIGS. 3A, 3B, and 3C provide examples of offer, product, and transaction data, respectively, that are stored in the transaction and offer system of FIGS. 2A, 2B, and 2C;

FIG. 4 is a graphical representation of example data structures employable in the transaction and offer system of FIGS. 2A, 2B, and 2C;

FIG. 5 is a flow diagram illustrating an example method of transaction data gathering and storage, and offer matching, generation, tracking, and redemption;

FIG. 6 is a flow diagram illustrating an example method of transaction data retrieval and processing;

FIG. 7A is a flow diagram of an example method of capturing and processing an image of a paper receipt, and processing and storing the resulting transaction data, in which processing of the image occurs primarily in the server platform of FIG. 1;

FIG. 7B is a flow diagram of an example method of capturing and processing an image of a paper receipt, and processing and storing the resulting transaction data, in which processing of the image occurs primarily in the consumer client system of FIG. 1;

FIG. 8 is flow diagram of an example method of offer matching, generation, tracking, and redemption;

FIGS. 9A, 9B, 9C, and 9D are graphical representations of an example user interface provided on the consumer client system of FIG. 1;

FIGS. 10A, 10B, 10C, and 10D are graphical representations of an example user interface provided on an offer provider client system of FIG. 1; and

FIG. 11 is a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

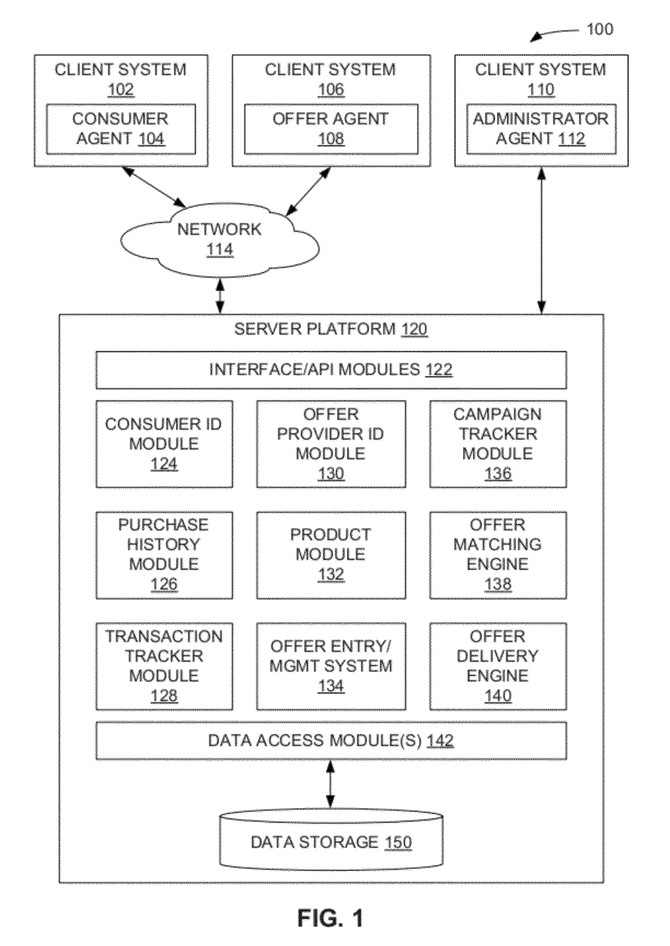

FIG. 1 is a block diagram depicting an example system 100, according to one exemplary embodiment, having a client-server architecture configured to perform the various methods described herein. A platform (e.g., machines and software, possibly interoperating via a series of network connections, protocols, application-level interfaces, and so on), in the exemplary form of a server platform 120, provides server-side functionality via a communication network 114 (e.g., the Internet or other types of wide-area networks (WANs), such as wireless networks or private networks with additional security appropriate to the tasks performed by a user) to one or more client systems 102, 106, 110. FIG. 1 illustrates, for example, a client system 102 hosting a consumer agent 104, thus allowing a consumer or customer to access those functions of the server platform 120 applicable to a consumer, including, for example, transaction data storage, offer receipt and redemption, and so on. In some instances, an intermediary acting on behalf of a consumer or group of consumers may access server platform 120 via the same interface as the consumer client system 102. For example, an institution that holds consumer item-level data (e.g., a bank, a mobile payment provider, or the like) may use the server platform 120 to present its users with offers generated by the system 100.

Another client system 106 hosts an offer agent 108 that facilitates use of the server platform 120 applicable to manufacturers, merchants, retailers, and so on, for specifying, tracking, and otherwise managing offers. A further client system 110 may include an administrator agent 112, thus allowing access to the server platform 120 for development, maintenance, upgrade, and associated activities related to the overall operation and control of the server platform 120. Examples of the client systems 102, 106, 110 may include any of a number of computing devices, such as desktop and laptop computers, tablet computers, smart phones and other mobiles communication devices, and so on.

As shown in FIG. 1, the client system 110 associated with the administrator agent 112 may be coupled more directly to the server platform 120, thus circumventing the network 114. For example, the client system 110 may be co-located with the server platform 120, coupled thereto via a local network interface. In another example, the client system 110 may communicate with the server platform 120 via a private or public network system, such as the network 114.

At least some of the embodiments described herein with respect to the system 100 of FIG. 1 provide various techniques for generating offers for the purchase of products, services, and the like that are personalized or tailored to the customer receiving the offer. In the examples described below, the system 100 may receive and aggregate transaction data, including item-level data about purchases, from a number of different data sources. These data sources may include, but are not limited to, paper receipts held by customers that specify individual items purchased, electronic item-level transaction data provided by merchants (e.g., retailers), and electronic item-level transaction data provided by payment provider systems. Other examples of sources containing such item-level transaction data include electronic receipts held by customers or other parties and data collected by third-party transaction data aggregators. In some examples, this transaction data may be mapped to more standardized product data to identify with a degree of specificity the individual products that have been purchased. The transaction data may then be compared against potential purchase offers or incentives supplied by manufacturers, retailers, consumer promotion agencies, and other entities. In one example, if the transaction data of a customer matches one of the potential offers, the offer may then be delivered to the customer. The customer may then take advantage of the offer, resulting in some benefit being conferred on the customer, such as a discount in the purchase of another product, a cash disbursement, an account credit, a rebate, or the like.

In at least some examples, the server platform 120 may be one or more computing devices or systems, storage devices, and other components that include, or facilitate the operation of, various execution modules depicted in FIG. 1. These modules may include, for example, interface/API modules 122, a consumer identifier module 124, a purchase history module 126, a transaction tracker module 128, an offer provider identifier module 130, a product module 132, an offer entry/management system 134, a campaign tracker module 136, an offer matching engine 138, an offer delivery engine 140, and one or more data access modules 142. Each of these modules is described in greater detail below.

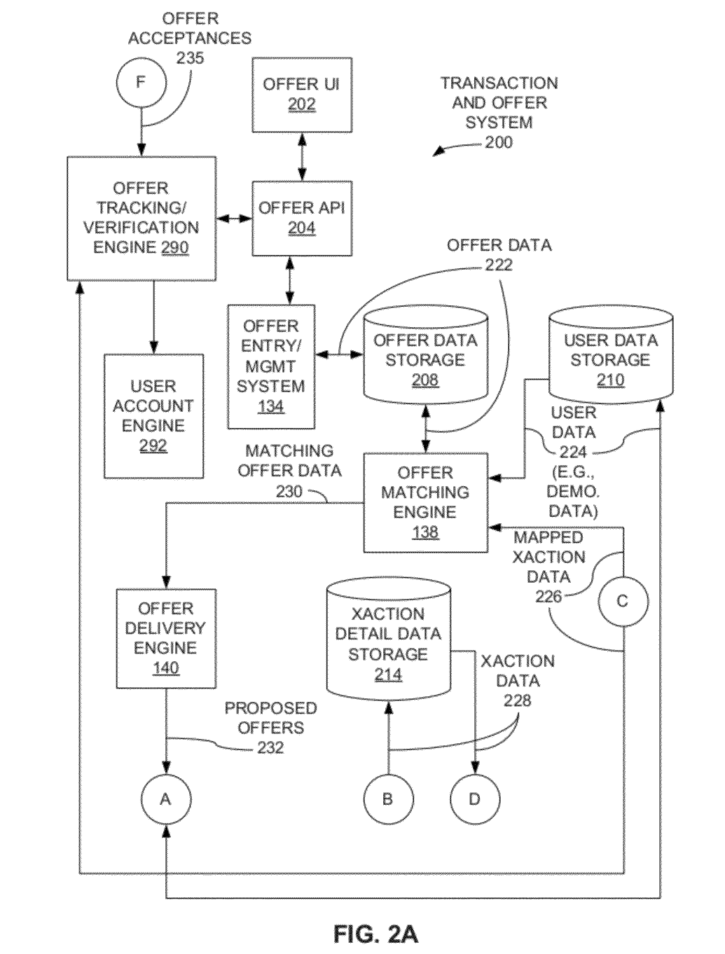

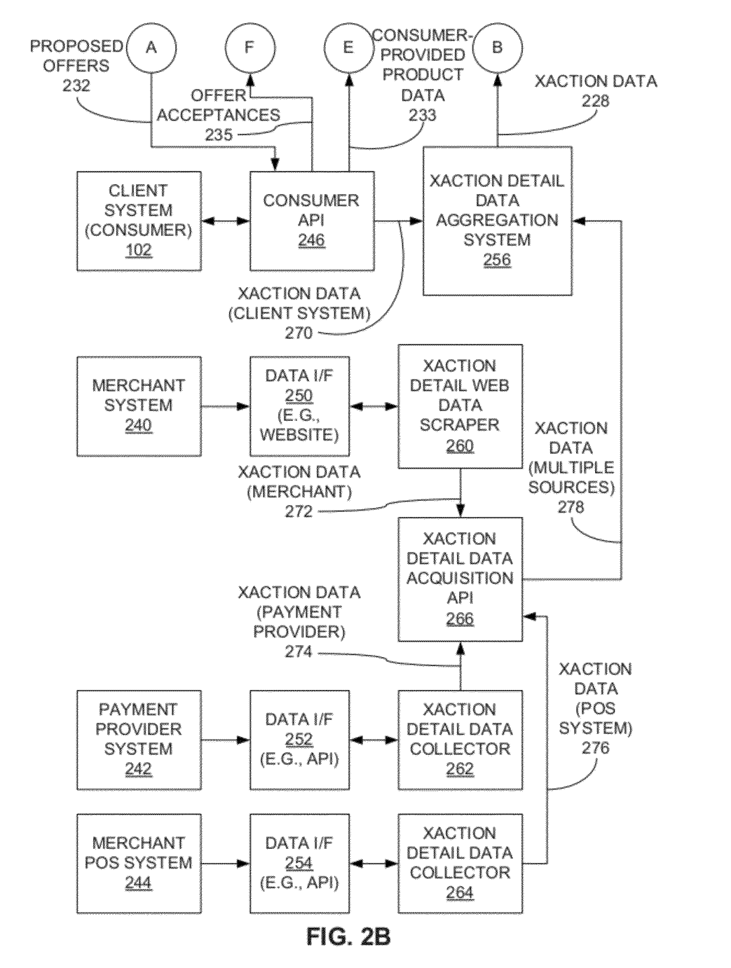

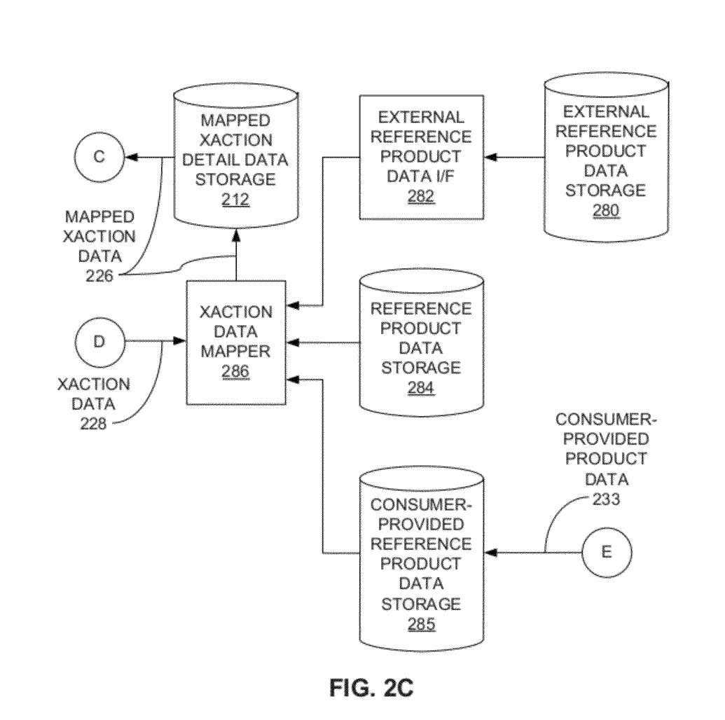

To facilitate communication between the client systems 102, 106, 110 and the server platform 120, the server platform 120 includes interface/API modules 122, which may provide a web interface, an API, or another type of interface facilitating access by the client systems 102, 106, 110 to the various modules 124-142 of the server platform 120. Some specific examples of the interface/API modules 122 are discussed below in conjunction with FIGS. 2A through 2C.

Data access modules 142 may facilitate access to data storage 150 of the server platform 120 by any of the remaining modules 122-140 of the server platform 120. In one example, one or more of the data access modules 142 may be database access modules, or may be any kind of data access module capable of storing data to, and/or retrieving data from, the data storage 150 according to the needs of the particular module 122-140 employing the data access modules 142 to access the data storage 150. Examples of the data storage 150 include, but are not limited to, one or more data storage components, such as magnetic disk drives, optical disk drives, solid state disk (SSD) drives, and other forms of nonvolatile and volatile memory components.

The consumer identifier module 124 may manage identifying information for each consumer accessing the server platform 120, possibly including, but not limited to, actual names, usernames, passwords, contact information, and additional information pertaining to the consumers. In some examples, this additional information may include user preference information, demographic information, previous purchase information, and other data related to the particular user. Uses for these types of information are described in greater detail below. Similarly, the offer provider identifier module 130 may manage identifying information for users representing a manufacturer, merchant, retailer, or similar entity that accesses the server platform 120. Analogous to the consumer identifier module 124, the offer provider identifier module 130 may manage names, usernames, passwords, contact information, and other information pertaining to the users representing a manufacturer or other entity. In one implementation, the identifying information associated with each consumer or user may be stored to, and retrieved from, one or more components of the data storage 150.

Continuing with FIG. 1, the purchase history module 126 may retrieve, store, and otherwise aggregate or manage item-level transaction or purchase data generated by multiple sources for a plurality of consumers. As mentioned earlier, such data may be received from a number of sources, such as paper receipts held by the consumer; electronic transaction data provided by a merchant, a payment service provider, and a third-party aggregator; loyalty website data; and so on as described above.

The transaction tracker module 128 may monitor or track the various item-level transaction data as they are received into the server platform 120 for a number of purposes related to purchase offers. In some examples, the transaction tracker module 128 may analyze transaction item-level data for the purposes of offer matching, offer generation, offer triggering, offer redemption, and the like.

The product module 132 may map the transaction data received via the purchase history module 126, which may be expressed in a variety of data formats, and map, convert, or transform that data into a more standardized format for use in offer generation, triggering, and redemption. For example, the received transaction data may be in the form of SKUs (stock-keeping units), UPCs (Universal Product Code), order numbers, item numbers, abbreviated product descriptions, and so forth. Such data may then be mapped to the more standardized format, such as UPCs or other product identifiers.

The offer entry/management system 134 may receive parameters regarding one or more offers devised by manufacturers, retailers, and other entities for possible presentation to one or more users. In an example, such parameters may include the type of offer (e.g., a loyalty reward, a new customer incentive, a reward to switch away from another retailer or manufacturer, a reward for a customer that has proven to be more lucrative than others, etc.), the products to be purchased and any customer attributes that would trigger the delivery of an offer to a consumer, the terms of the reward or incentive resulting from triggering the offer, any expiration date or time associated with the offer, and so on. The user of the offer client system 106 may devise such offers, modify the offers in response to interim results regarding the offer, and engage in related activities via the offer entry/management system 134.

The campaign tracker module 136 may monitor or track the status or progress of the various offers currently in effect. Such activity may include tracking which offers have been delivered to which consumers, which consumers have accepted and/or redeemed the offers, and the like. In some embodiments, the campaign tracker module 136 may also track statistics regarding the acceptance and redemption rates of current offers versus previous offers, as well as generate other metrics allowing a user representing a manufacturer or other entity to compare the relative success of various offers, past and present, to adjust the parameters defining current and future offers. More specifically, the campaign tracker module 136 may generate analytical and/or statistical reports showing the status of ongoing promotions; levels of promotion redemptions; consumer purchase patterns relative to specific products, product categories or other item classes; geographic purchase patterns; price trends; and other consumer-related, retailer-related, or purchase-related statistics. The campaign tracker module 136 may also generate projections about campaign duration and effectiveness, including conversion, engagement, and redemption rates and projected times to completion of ongoing promotion campaigns. Such statistics may be sorted and presented according to consumer attributes, consumer demographics, consumer and purchase locations, retailer identity, and other parameters. The campaign tracker 136 may compile and monitor these statistics in real-time, thus allowing the offer providers to adjust the outstanding offers to increase offer redemption or achieve one or more other goals.

The offer matching engine 138 may match offers defined or generated by the various manufacturers, merchants, retailers, or other entities with one or more consumers based on previous purchases of items by the customers, as set forth by the parameters defining the offers. The offer matching engine 138 may also consider other factors in matching offers to consumers, such as the demographic details of the consumers, their user preferences, locations where they have shopped previously, and other information associated with the consumers. In some examples, the offer matching engine 138 may also consider items placed on a shopping list or virtual basket of goods specified by the consumer for future purchase.

The offer delivery engine 140 may deliver the offers matched by the offer matching engine 138 to their corresponding consumers via the client system 102 associated with the consumer. The delivery of the offers may occur in a number of ways, such as by e-mail, Short Message Service (SMS), or another messaging service, by displaying an offer to a consumer in a form on a webpage, within a mobile computing device application, through an interactive television medium, via a short video or animation, or by other means. In one implementation, such offers may be displayed on a screen of a mobile client consumer system 102 for presentation to a retailer at a point of sale. In one example, the offer delivery engine 140 may provide all offers relevant to a shopping list or virtual “basket of goods” specified by the consumer or the system 100 to the consumer via the consumer client system 102. In another implementation, the offer delivery engine 140 may provide all such offers relevant to a particular merchant as a group of offers. In yet another example, the offer delivery engine 140 may generate a single offer via the offer matching engine 138 that provides an overall discount applicable to an entire basket of goods, as opposed to individual items, to simplify presentation to the retailer for the associated discount. Moreover, the offer delivery engine 140 may deliver offers associated with a specific retailer to the consumer while a mobile client consumer system 102 is located at the retailer. The location of the mobile client consumer system 102 may be determined by way of a Global Positioning System (GPS) circuit operating in the mobile client consumer system 102, or by the entry of data (e.g., a credit card number) identifying the consumer at a point of sale system of the retailer.

The modules 122-150 depicted in FIG. 1 represent one particular embodiment of the system 100. In other implementations, some modules may be combined to form fewer modules, some modules may be separated into separate, more numerous modules, some modules may be removed while others are added, and the like. Also, while the data storage 150 is shown in FIG. 1 as a unitary module residing entirely within the server platform 120, the data storage 150 may be provided by one or more systems internal and/or external to the server platform 120 in other embodiments.

FIGS. 2A, 2B, and 2C present a block diagram of an example transaction and offer system 200 including modules and data storage employable in the server platform 120 of FIG. 1. Generally, FIG. 2A describes offer matching, tracking, and delivery, FIG. 2B depicts item-level transaction data retrieved from multiple sources, and FIG. 2C illustrates the mapping of the item-level transaction data using more standardized product data. While many modules, as well as the data passed therebetween, are depicted in FIGS. 2A, 2B, and 2C, other modules and associated data flow may not be illustrated therein to simplify FIGS. 2A through 2C and the attendant discussion.

More specifically in FIG. 2A, an offer user interface (UI) 202, which may exist as part of the offer agent 108 of the client system 106 or as an interface/API module 122 of the server platform 120, allows a representative of a manufacturer, retailer, or other entity providing offers to interact with the offer entry/management system 134 and an offer tracking/verification engine 290 via an offer API 204. The offer API 204 may be one of the interface/API modules 122. In one example, the offer tracking/verification engine 290 may include both the transaction tracker module 128 and the campaign tracker module 136 of FIG. 1.

A user account engine 292 of FIG. 2A, in one embodiment, may receive instructions from the offer tracking/verification engine 290 to fulfill redemptions of offers to consumers. For example, the user account engine 292 may make adjustments to the balance of a user's or consumer's account if redemption of the one or more offers triggers cash, credit, points, or similar deposit into, or withdrawal from, the consumer account, such as by way of a direct deposit to a bank account or other account of the consumer via an automated clearing house (ACH) transfer or a wire transfer, a check delivery via mail, and the like. In some implementations, the system 100 may facilitate consumers sharing or transferring savings, earnings, credits, rebates, or other earned benefits provided by the offers with other consumers or groups of consumers via the accounts of the consumers. Similarly, consumers may share these benefits with one or more organizations, such as schools, churches, teams, or other designated groups thereof. In another example, the user account engine 292 may provide notifications, code, or some other data to a consumer via a consumer API 246 (FIG. 2B) and the consumer client system 102 to allow the consumer to receive a discount, credit, goods, redemption of balances into cash or cash-like instruments, or apply such balances to a future purchase of one or more items. In yet other implementations, the system 100 may transfer accumulated earnings or rewards to non-cash purchase credits deposited onto a retailer loyalty card, an account provided by a retailer, a credit card, a gift card, and so on. Such transfers may be at a one-to-one exchange rate, or at any other exchange rate. The consumer may then spend these rewards or earnings on specific products or services, possibly via an electronic commerce platform or portal that treats such earnings as cash equivalents. Other forms of redemption associated with an offer may also be supplied via the user account engine 292 in other examples.

Three possible components of the data storage 150 of FIG. 1 are employed in FIG. 2A: offer data storage 208, user data storage 210, and transaction detail data storage 214. In one example, the offer data storage 208 may store offer data 222 generated by multiple offer providers, such as manufacturers, retailers, and other users of the system. More specifically, each offer may be defined by one or more offer parameters, such as those discussed above (e.g., offer type, offer product(s), offer terms, applicable customer attributes, and triggering product(s)). This data may be stored or updated by the offer UI 202, the offer API 204, and the offer entry/management system 134.

The user data storage 210 may store user data 224 describing and/or identifying each of a plurality of consumers or users. Such information may include, in one example, a customer name and/or identifier, contact information (e.g., address, phone numbers, e-mail addresses, etc.), demographic information (e.g., age, gender, marital status, income level, educational background, number of children in household, etc.), user preferences (such as preferences or reviews regarding favorite products and/or services, favorite shopping outlets, and so on), and previous transaction information (e.g., spending profile of the user, past purchase spending levels on goods sold by various manufacturers or merchants, the frequency of shopping by the user at one or more retail outlets, store loyalty exhibited by the user, how much the user spends in an average transaction, how much the user has spent on a particular basket of goods, how often the user shops in a particular store or kind of store, the estimated profit margin on goods previously purchased, the distances the user has traveled to purchase products in past outings, the amount of fuel expended by the user during an outing, the online or offline stores at which the user has purchased items, the tendency of the user to purchase items on sale, the tendency of the user to purchase items only listed in a basket of goods, and the like).

In additional examples, the user preference information and/or the previous transaction information of the user data storage 210 may include information regarding a consumer's level of engagement with previous offers provided to the consumer. For example, in addition to storing whether the consumer accepted and/or redeemed a particular offer, the transaction and offer system 200 may detect and store information regarding more intermediate forms of engagement with the offer by the consumer, including, but not limited to, whether the consumer viewed an offer in an online product gallery, answered a poll about a product involved with the offer, requested additional information (e.g., in the form of text, audio, video, and so forth) concerning the offer or product, and shared a particular product offer with another person. This additional information thus permits the transaction and offer system 200 to more finely analyze and distinguish the behavior of consumers, and thus to target offers to the consumers with more accuracy.

Other or different information related to each of the users may be stored in the user data storage 210 in other examples. In one implementation, a consumer may provide such information via a client system 102 employed by the consumer by way of the consumer API 246. In some examples, such data may also be acquired via the Internet, by third-party organizations holding such information, and other means.

The transaction detail data storage 214 stores item-level transaction data 228 from the transaction detail data aggregation system 256 (FIG. 2B), described in greater detail below. In one example, the item-level transaction data 228 may include data describing transactions for products or services from a plurality of users or consumers in a number of different formats prior to that data being mapped or translated into a more standardized format. As discussed more fully below, a transaction data mapper 286 (FIG. 2C) may access the item-level transaction data 228 to perform the mapping function.

The other modules presented in FIG. 2A (e.g., the offer entry/management system 134, the offer matching engine 138, and the offer delivery engine 140) operate as described above in connection with FIG. 1.

FIG. 2B depicts how the item-level transaction data 228 may be retrieved from any of multiple sources and aggregated for storage in the transaction detail data storage 214. As shown, the item-level transaction data 228 may be received from one or more consumer client systems 102, web-accessible merchant systems 240, payment provider systems 242, and merchant point-of-sale (POS) systems 244. Other potential entities, such as other individuals or corporations, may serve as sources of the item-level transaction data in other implementations.

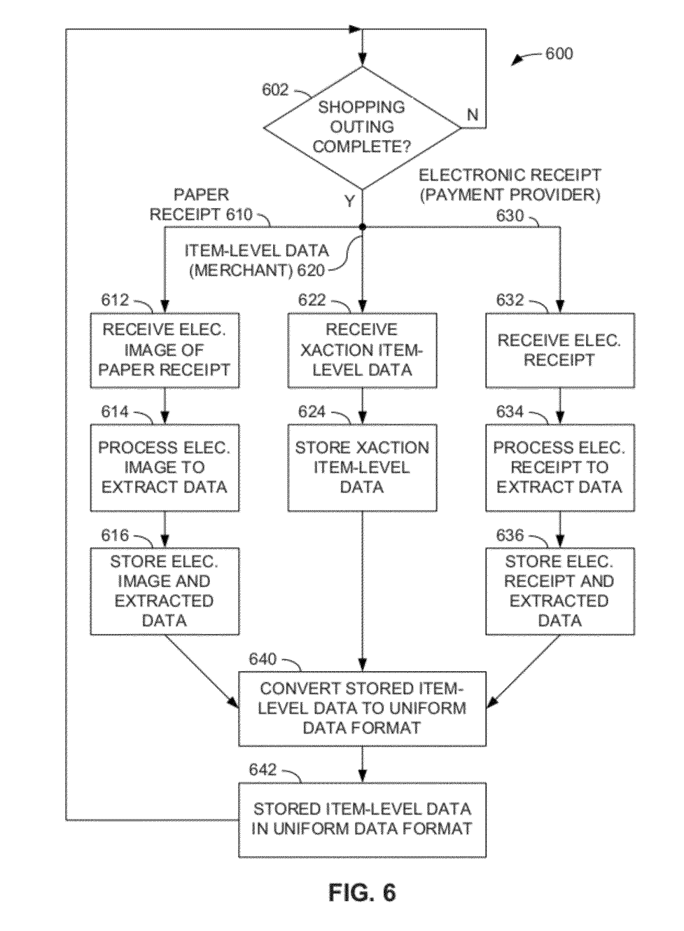

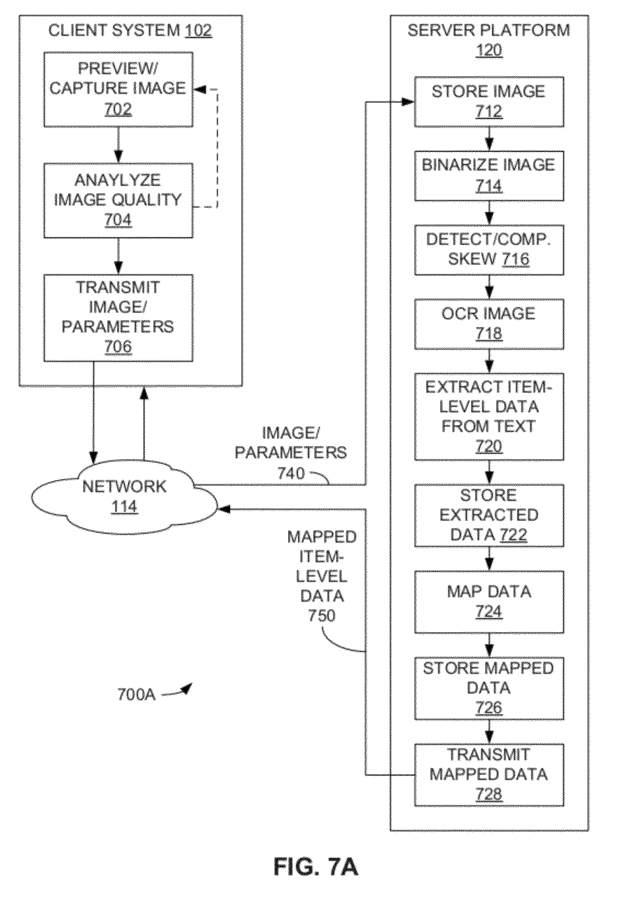

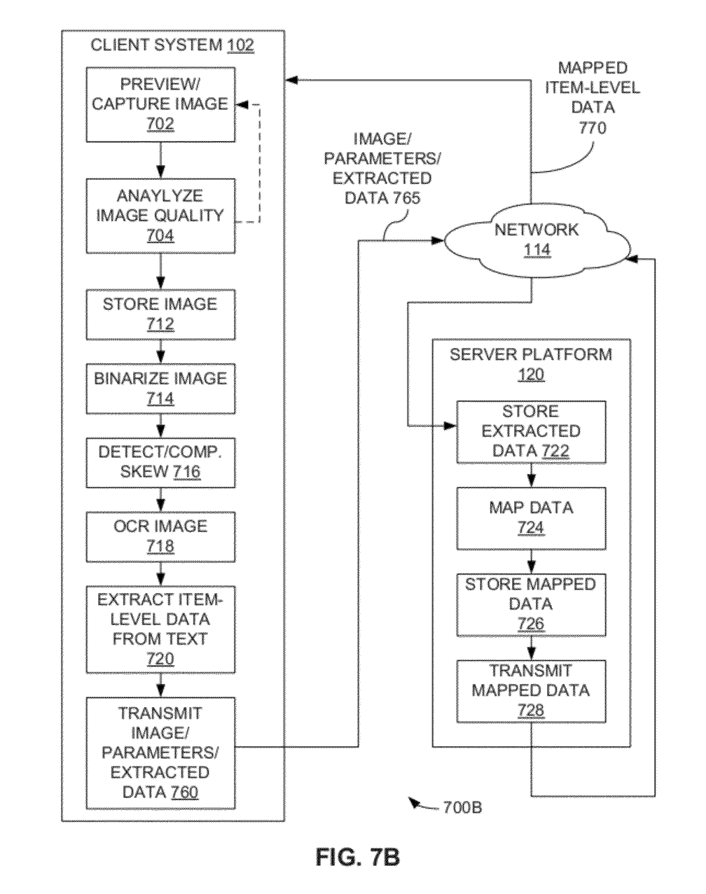

In the case of the consumer client system 102, the transaction data initially may be in the form of paper receipts provided by one or more retailers that list individual items or services purchased by the consumer. In one example, the consumer operating the consumer client system 102 may scan and/or photograph a paper receipt, the resulting image of which is then processed to generate data identifying the various items purchased. This processing of paper receipts is discussed in greater detail hereinafter with respect to FIGS. 6, 7A, and 7B.

In other examples, the consumer client system 102 may receive an electronic receipt or similar data from a retailer. Such information may be received as information displayed on a webpage to the consumer, as text provided in an e-mail message, SMS message, or other communication and/or electronic record transmitted to the consumer, as data received from an “electronic wallet” or other mobile payment system, or via other means. In one example, the consumer client system 102 may receive electronic purchase information, including item-level transaction detail data, at a point-of-sale via short-range wireless communication, such as near field communication (NFC). This information may then be supplemented by data indicating the location of the consumer client system 102, and hence the retailer at which the purchase takes place. This location data may be generated via GPS circuitry in a mobile device of the consumer, or may be received from a point-of-sale system of the retailer. The electronic receipt may then be processed by way of parsing the received information to extract the item-level transaction data of interest.

For purchases made via a website, a browser application executing on the consumer client system 102 may include a “plug-in” that captures and records purchases made by the consumer via the consumer client system 102. In another example, software may be executed on the consumer client system 102 to identify, collect, and transmit receipt information and data stored on the consumer client system 102 for processing by the transaction and offer system 200. In yet another implementation, software may be executed on the consumer client system 102 to identify various external sources of receipt data and transmit information about the sources to the transaction and offer system 200 for further processing. The consumer client system 102 may also identify external sources of receipt data, collect the receipt information from those sources, and transmit the collected information to the transaction and offer system 200 for further processing. In yet other examples, the consumer client system 102 may receive item-level transaction data via manual entry by the consumer through a web interface, mobile application, or other mechanism providing a user interface for such a purpose.

In some implementations, the consumer may specify one of multiple consumer accounts in the system 100 to allow a consumer to attribute a purchase to a particular account (e.g., a personal account or a business account), or to attribute a purchase to an account of another consumer, such as a family member.

The receipt information and/or item-level transaction data received or generated at the consumer client system 102 may then be provided to the transaction detail data aggregation system 256 as client device transaction data 270 by way of the consumer API 246 provided at the server platform 120. The consumer client system 102 may provide the transaction data immediately, such as at the point of sale or time of transaction, or at some later time, such as when the consumer client device 102 is synchronized with a larger computer system or is within range of a wireless communication network.

Another source of item-level transaction data may be the merchant system 240. In some implementations, the merchant system 240 may provide item-level transaction data for multiple consumers that have purchased products or services from the merchant who operates the merchant system 240. In one example, a consumer may explicitly authorize the merchant system 240 to provide the transaction data pertaining to the customer. In some implementations, the merchant system 240 may post the item-level transaction data to a data interface 250, such as a secure website or other network portal, upon completion of each consumer transaction or at periodic or predefined intervals. A transaction detail web data scraper 260 may then retrieve the posted transaction data periodically from the website or portal and provide the retrieved transaction data as merchant transaction data 272 to the transaction detail data aggregation system 256 via a transaction detail data acquisition API 266.

Similarly, the payment provider system 242, such as a third-party entity for facilitating payment transfers between the consumer and the merchant, may provide item-level transaction data pertaining to transactions between multiple consumers and merchants to a second data interface 252, such as an API or a secure website. Depending on the embodiment, the payment provider system 242 may provide the data for a particular transaction upon completion of that transaction, or may collect data for multiple transactions and transfer the data in batches periodically or according to some schedule. A first transaction data collector 262 may retrieve the posted transaction data from the second data interface 252 and deliver the transaction data as payment provider transaction data 274 to the transaction detail data acquisition API 266, which then transfers the data to the transaction detail data aggregation system 256 as transaction data 278.

As mentioned above, the merchant POS system 244 may be another source of item-level transaction data. Examples of the merchant POS system 244 may include computing systems located at physical retail locations responsible for generating item-level transaction data at the associated location. The merchant POS system 244 may provide item-level transaction data pertaining to transactions between multiple consumers and the merchant to a third data interface 254, such as an API. In one example, the data from the merchant POS system 244 may be transferred to the third data interface 254 via a back-end system (not depicted in FIG. 2B), which may serve multiple retail locations of the merchant. In some implementations, the merchant POS system 244 or the back-end system may determine which consumers have consented to have their transaction data relayed to the third data interface 254 prior to transferring that data. The merchant POS system 244 may identify the consumer for this purpose by way of personal or contact information of the consumer provided by the consumer during the transaction, the number of the credit card employed by the consumer to pay for the transaction, a loyalty member number of the customer, or a consumer-specific barcode or quick response (QR) code. In other examples, the consumer may consent to allow the transfer of the item-level transaction data to occur for all transactions, only for certain transactions specifically designated by the user, or only for transactions involving certain merchants.

Similar to the payment provider system 242, the merchant POS system 244 may provide the data for each transaction upon completion of the transaction, or may collect data for multiple transactions and transfer the data periodically or according to a predetermined schedule. A second transaction data collector 264 may then retrieve the posted transaction data from the third data interface 254 and deliver the transaction data as POS system transaction data 276 to the transaction detail data acquisition API 266, which then transfers that data to the transaction detail data aggregation system 256 as transaction data 278.

In some implementations, the various systems 240, 242, 244 may push the data to the transaction detail data acquisition API 266 without the assistance of the transaction detail web data scraper 260 and the transaction detail data collectors 262, 264. Further, any or all of the transaction data depicted in FIGS. 2A and 2B may be encrypted prior to transmission to promote security of the data.

In response to receiving the client device transaction data 270 and the transaction data 278 from the remaining sources, the transaction detail data aggregation system 256 may aggregate and otherwise process the data and store the resulting transaction data 228 at the transaction detail data storage 214 (FIG. 2A). In some implementations, the transaction detail data aggregation system 256 may filter out duplicate item-level transaction data that is retrieved or received from multiple sources to ensure that a particular purchased product or service is not represented more than once in the aggregated transaction data 228. For example, the consumer client system 102 may transmit transaction data provided on a paper receipt to the transaction detail data aggregation system 256, while the merchant POS system 244 associated with that same transaction may provide the same or similar data.

In FIG. 2C, a transaction data mapper 286 may receive or retrieve the transaction data 228 from the transaction detail data storage 214 and map that data to more standardized product data retrieved from one or more sources. In one example, each item represented in the product data may be identified by a UPC or other standardized or unique identifier, possibly supplemented by a description of the product or other information. As illustrated in FIG. 2C, one possible source of product data is the reference product data storage 284 provided by the server platform 120. In one example, the reference product data storage 284 may include item-level product data previously received at the server platform 120 from other external product databases (e.g., various databases by Gladson®, or Kwikee® by MultiAd®, Inc.) or public repositories, or provided directly or indirectly by consumers, manufacturers, or retailers.

The transaction data mapper 286 may also receive product data in the form of consumer-provided product data 233 received from one or more consumer client devices 102 via the consumer API 246 (FIG. 2B) discussed above and stored in a consumer-provided reference product data storage 285 (FIG. 2C). One or more consumers may provide such data by entering the UPC and other identifying information for the product manually through a user interface of the consumer client device 102, by scanning the UPC and manually entering a description of the product, by photographing the packaging of the product (including the UPC), by uploading or otherwise transmitting images of a paper receipt containing item-level data, or by other means. “Crowd-sourcing” of such information from many consumers may increase the number of products for which detailed product information may be provided to the transaction and offer system 200. In addition, information for any particular product may be provided by multiple consumers, thus allowing the transaction and offer system 200 to process multiple types of information about the same product to produce more complete, detailed data regarding that product compared to what may be provided by a single consumer.

In an example, the transaction data mapper 286 may also retrieve product data from an external reference product data storage 280 located external to the server platform 120 via an external reference product data interface 282. The retrieved product data may include, for example, a UPC for each product or item of interest and images for each product, as well as other identifying data. The external reference product data interface 282 may access the external product data storage 280 via a secure website, via an API, or the like.

Accordingly, the transaction data mapper 286 may receive product data from one or more consumer client devices 102, the external reference product data storage 280, and/or the internal reference product data storage 284. The transaction data mapper 286 may aggregate, and possibly further process, the retrieved product data before mapping the transaction data 228 received from the transaction detail data storage 214 to the received product data and storing the resulting mapped transaction data 226 in a mapped transaction detail data storage 212. In one example, the transaction data mapper 286 may filter out duplicate product data entries identifying the same product and may combine and/or prioritize multiple product data entries to produce the most accurate and detailed data for a product, in addition to other possible data processing functions. In one example, the transaction data mapper 286 may map transaction data 228 for a particular purchased item by updating that data to include a UPC, product image, or other unified or standardized data for that item, as provided by the product data received at the transaction data mapper 286.

Given the contents of the offer data storage 208, the user data storage 210, and the mapped transaction detail data storage 212, the transaction and offer system 200 may generate purchase offers that are targeted to individual customers or identifiable groups thereof, present those offers to the consumers, monitor and reward redemptions of the offers by the consumers, modify offers based on the redemption rates of the offers and other factors, and so forth. In one embodiment, the transaction and offer system 200 may record and analyze a given consumer's purchasing habits and behavior, including that consumer's behavior relative to previous purchase offers. These habits and behavior may then be memorialized in the user data storage 210 along with other consumer traits and characteristics, which may then be used by the transaction and offer system 200 as criteria for future purchase offers. Thus, the elasticity of demand of a consumer for a particular product or brand may be measured, stored, and then employed in future offer presentations, thus allowing manufacturer and merchant agents to personalize offers and, therefore, pricing of products for that particular consumer.

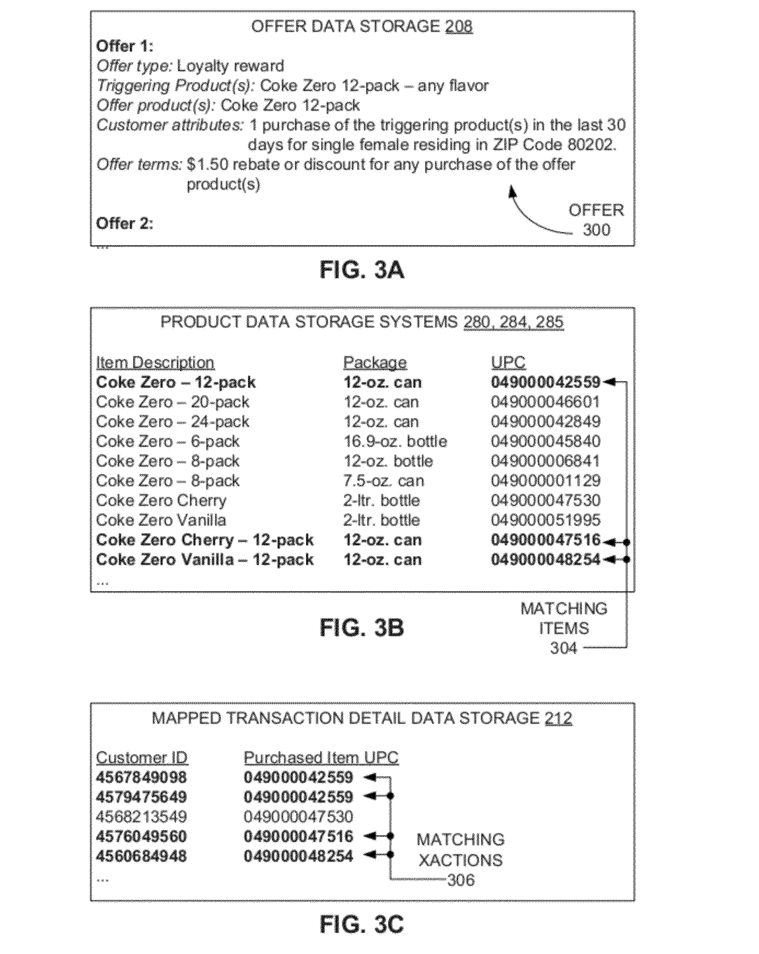

Returning to FIG. 2A, in operation, a manufacturer, retailer, or other commercial entity may communicate with the offer entry/management system 134 via the offer client system 106 and the offer agent 108, in communication with the offer UI 202 and offer API 204, to specify and/or modify purchase offers for presentation to one or more consumers. The resulting offer data 222 are stored in the offer data storage 208. The offer matching engine 138 may then access portions of the offer data 222 from the offer data storage 208, user data 224 from the user data storage 210, and the mapped transaction data 226 from the mapped transaction detail data storage 212 to match current offers with one or more consumers represented in the user data storage 210. A description of a particular example of matching offers with consumers is described below in connection with FIGS. 3A, 3B, and 3C.

Those offers that are matched with one or more consumers are represented in matching offer data 230 that the offer matching engine 138 may deliver to the offer delivery engine 140. In turn, the offer delivery engine 140 communicates the proposed offers 232 to the targeted consumers by way of an e-mail message, an SMS message, a mobile application notification, a web page, a web application notification, and/or other means of delivery by way of the consumer API 246 to the consumer client systems 102 of interest. Further, in some examples, the offer delivery engine 140 may receive acceptances of the proposed offers from consumers. In these cases, a consumer may be required to accept an offer 232 before performing in whatever manner may be necessary to redeem the offer 232.

The offer tracking/verification engine 290 may then determine which offers have been redeemed by which consumers by tracking or monitoring the mapped transaction data 226 stored at the mapped transaction detail data storage 212. In one example, if a consumer that has received an offer has purchased one or more products required by the offer, or has performed in some other manner as set forth in the offer, the offer tracking/verification engine 290 may detect that performance and provide the reward or benefit associated with the offer. In one example, the offer tracking/verification engine 290 communicates with the user account engine 292 to cause the user account engine 292 to provide the reward or benefit, such as by providing a credit (e.g., money, loyalty program points, etc.) to an account of the consumer. The account may be a bank account, a credit card account, a loyalty program account, or the like.

FIGS. 3A, 3B, and 3C provide an example of data stored in the offer data storage 208, the various reference product data storage systems 280, 284, 285 and the mapped transaction detail data storage 214, respectively. In this example, the offer data storage 208 includes multiple parameters of each offer 300 listed therein. As shown in FIG. 3A, the parameters of an offer 300 may include an offer type, an identification of one or more triggering products, one or more offer products, one or more customer attributes, and offer terms. The offer type may indicate the type of offer or corresponding reward associated with the offer, such as a customer loyalty reward, an incentive to become a new customer or to switch away from a competitor, or an incentive associated with a particular level or degree of engagement between the consumer and the product or brand. The triggering products may be products that, when purchased by a consumer, cause the associated offer to be delivered to the consumer. The offer products may be the products that the consumer is required to purchase in order to redeem the offer, and thus to receive the reward or benefit of the offer. The customer attributes may be those attributes of a consumer that are to be satisfied to qualify the consumer to receive the offer. Such attributes may include demographic attributes or other attributes of the consumer, as well as one or more past transactions completed by the consumer. The offer terms may specify the actual benefit or reward to be provided to the consumer upon redemption of the offer. Other parameters, such as any geographic or other restrictions pertaining to the offer, eligible retail locations where offers may be redeemed, initial and expiration dates for redemption of the offer, starting and ending dates for triggering of the offer, a particular retailer from which the triggering or offer products are to be purchased, and so on, may be specified for each offer 300 represented in the offer data storage 208. In some examples, the total number of deliveries, acceptances, or redemptions of a particular offer entered by the offer entry/management system 134 may be limited.

In FIG. 3B, the example of the reference product data storage systems 280, 284, 285 depicted therein lists a number of products, each of which is identified by way of an item description, a package description, and a UPC. Greater or fewer types of information may be provided for each item or product listed in the reference product data storage systems 280, 284 in other examples. In this embodiment, each product may be identifiable in the reference product data storage systems 280, 284, 285 with a unique product identifier. In some examples, some products may be denoted as comparable or substitute products of other products in the reference product data storage systems 280, 284, 285. In addition, each product may be denoted by one or more manufacturer-specific or retailer-specific codes identifying the product.

The example mapped transaction detail data storage 212 illustrated in FIG. 3C lists item-level transaction data for multiple customers that are mapped to standardized product data. As described above, the transaction data mapper 286 generates this data from the reference product data storage systems 280, 284, 285 combined with item-level transaction data received from one or more sources. In the mapped transaction detail data storage 212, each purchased item stored as stored mapped transaction data 226 may be denoted by a UPC of the purchased item and a unique customer identifier. In one implementation, the transaction and offer system 200 generates the customer identifier in response to the customer or consumer registering with the system 200. In other examples, additional information regarding the transaction, such as the date of purchase and the location of purchase, may be included for each transaction item represented in the mapped transaction detail data storage 212. Additionally, the data stored in the mapped transaction detail data storage 212 may be organized according to consumer, and further according to transaction or shopping outing.

In the specific example described in FIGS. 3A, 3B, and 3C, the transaction data mapper 286 generates the mapped transaction data 226 in the mapped transaction detail data storage 212 using various Coke® Zero item UPCs from the reference product data storage systems 280, 284, 285 to update the transaction data to indicate that, for example, Customer 4567849098 purchased Item 049000042559 (e.g., a 12-pack of 12-oz. cans of Coke® Zero (original flavor)).

Meanwhile, in the offer data storage 208, the offer 300 labeled “Offer 1” provides a loyalty reward to a consumer that has satisfied specific customer attributes associated with the offer 300. More specifically, the offer data 300 indicates that the customer attributes for receiving the offer 300 include a single purchase of a triggering product within the last 30 days. In this example, the triggering product is any flavor of a Coke® Zero 12-pack. Thus, if a consumer has purchased a 12-pack of Coke® Zero in the last 30 days, the transaction and offer system 200 may then deliver the corresponding offer 300 to the consumer. In this example, the offer terms provide for a $1.50 rebate to be paid, or a $1.50 discount to be given, to a single female consumer residing in ZIP Code 80202 for purchasing the offer product, with the offer product being specified as a Coke® Zero (original flavor) 12-pack.

As a result of the offer 300 being stored in the offer data storage 208, the offer matching engine 138 may then monitor the mapped transaction detail data storage 212, and possibly the user data storage 210, to identify consumers who qualify to receive the offer. In the example illustrated in FIGS. 3A through 3C, the offer matching engine 138 may determine that the mapped transaction detail data storage 212 reports several matching transactions 306 involving UPCs that correspond with at least three different matching items 304 that match the triggering product stated in Offer 1. The matching items include a 12-pack of Coke® Zero (UPC 049000042559), a 12-pack of Coke® Zero Cherry (UPC 049000047516), and a 12-pack of Coke® Zero Vanilla (UPC 049000048254), each of which qualifies as a Coke® Zero 12-pack of any flavor. Thus, each of the matching transactions 306 may result in its associated customers, identified by the customer identifiers of 4567849098, 4579475649, 4576049560, and 4560684948, receiving Offer 1 via the offer delivery engine 140.

In a similar fashion, the offer tracking/verification engine 290, by way of its connection with the mapped transaction detail data storage 212, may monitor the transactions reported therein to determine if a consumer that has previously received an offer has performed according to the one or more offer terms of that earlier offer 300 (e.g., purchases a Coke® Zero (original flavor) 12-pack (UPC 049000042559)). Presuming that the consumer has successfully performed according to the offer terms, the offer tracking/verification engine 290 may then communicate with the user account engine 292 to provide the benefit or reward (in this case, the $1.50 rebate or discount) by, for example, crediting an account of the consumer that amount.

While the examples of FIGS. 3A, 3B, and 3C involve closely related products from a single manufacturer, such as similar types or sizes of a soft drink, the various triggering products, offer products, and other parameters of an offer 300 need not involve products so closely related, or even related at all. For example, an offer involving a discount off the price of a loaf of bread may be triggered by a purchase of a gallon of milk, or the purchase of one manufacturer's brand may trigger the presentation of an offer on a different manufacturer's brand. Consumers may be given offers that encourage them to purchase specific combinations of brands or products on a particular shopping outing. They may also receive rewards for purchasing specific brands or products over a pre-specified period of time or in a particular retailer. For example, the transaction and offer system 200 may offer a consumer a specified payment, rebate, or credit in response to the consumer buying a particular product or range of products a predetermined number of times within a specified time period, such as a month. The transaction and offer system 200 may also inform the consumer of successful offer redemptions, as well as progress the consumer has made toward any offers directed to the consumer.

The consumers may also receive offers that reward them for persuading their friends to engage in certain purchase behaviors, with each member of the team or group submitting item-level purchase data in one or more of the manners outlined above, and with the rewards benefitting one or more members of the team or group, or being donated to charitable or other causes on behalf of the team. For example, the transaction and offer system 200 may offer a specific team or group of consumers a predetermined payment, credit, or rebate in response to each of the group members purchasing a specific amount of a particular product or brand of product.

To facilitate group or team offers, the transaction and offer system 200 may allow a consumer to invite other consumers, such as friends and relatives connected to the consumer via a social network graph or website, to join the first consumer in a team. The transaction and offer system 200 may then monitor the item-level transactions and other activities of the group members to determine progress toward redemption of a group offer. The transaction and offer system 200 may also inform each team member of their individual and/or team progress toward one or more offers presented to the team. In some examples, a team leader or organizer may also receive commissions in the form of payments, credits, or rebates based on individual or overall team performance toward offer redemption. Aside from the various individual and team-oriented offers described herein, numerous other examples of offer types also exist.

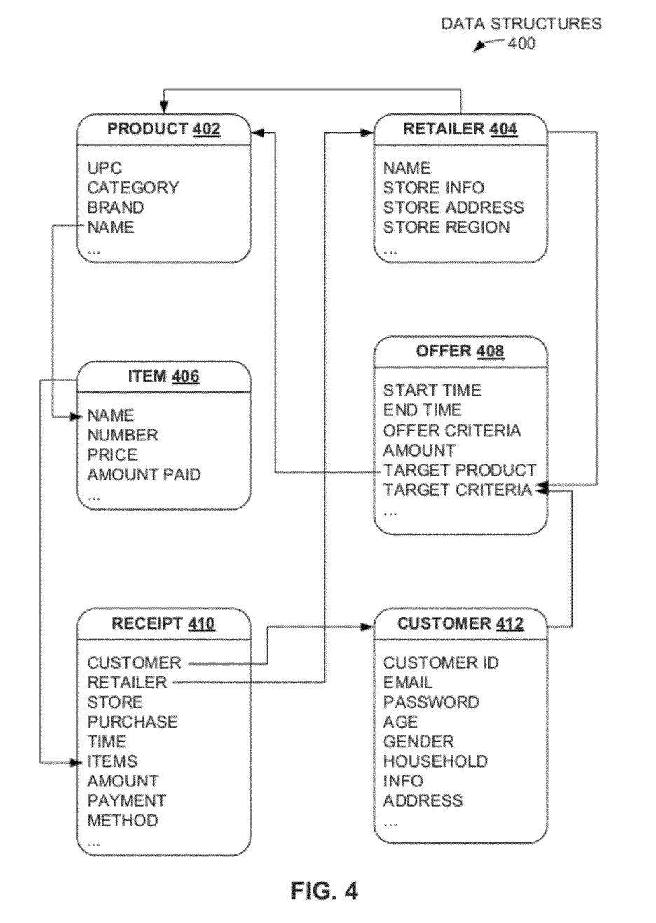

FIG. 4 is a graphical representation of example data structures 400 employable in the transaction and offer system 200 of FIGS. 2A, 2B, and 2C. At a high level, one or more data structures 400 are associated with each entity or item of interest of the transaction and offer system 200. As shown in FIG. 4, the data structures 400 may include a product data structure 402 for each product (as stored in the reference product data storage systems 280, 284, 285), a retailer data structure 404 for each retailer or merchant registered with the transaction and offer system 200, an item data structure 406 identifying each purchased item (as stored in the transaction detail data storage 214 and/or the mapped transaction detail data storage 212), an offer data structure 408 for each offer present in the system 200 (as stored in the offer data storage 208), a receipt data structure 410 for each receipt (whether electronic or paper in origin) associated with a shopping outing, and a customer data structure 412 for each customer registered with the transaction and offer system 200.

Each of the data structures 400 may include data fields for carrying specific types of data associated with the encompassing data structure 400. For example, the product data structure 402 includes data fields for at least a UPC for the product, a product category, a product brand, and a product name. While specific data structure types and data fields are indicated in FIG. 4, other schemes for the data structures 400 and included fields are possible in other implementations.

Also depicted in FIG. 4 are links, pointers, or similar structures (as illustrated by the directional arrows provided therein) indicating how the various data structures 400 may be associated with each other. For example, a particular receipt data structure 410, to identify a customer and a retailer of the transaction identified in the receipt data structure 410, may link or point to the specific customer data structure 412 and retailer data structure 404 representing the associated customer and retailer, respectively. Examples of other links or pointers connecting data structures or data fields therein are presented in FIG. 4. While FIG. 4 generally depicts a relational data structure, a person of ordinary skill in the art will understand that other types of data structures (e.g., NoSQL data stores, such as document store, column-oriented store, key value store, and others) may be used in this and other embodiments in place of, or in combination with, the data structures 400 of FIG. 4. Such data structures may appear with various data store types (e.g., data warehouse, distributed data store, active data store, unstructured data store, and so on).

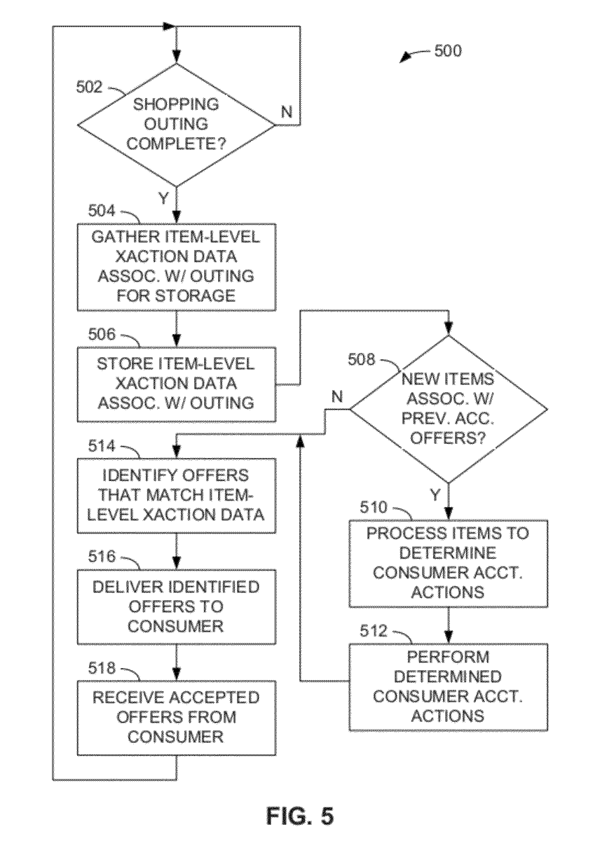

FIG. 5 is a flow diagram illustrating an example method 500 of transaction data gathering and storage, and offer matching, generation, tracking, and redemption, as described above. In the method 500, for each shopping outing that is completed by a consumer (operation 502), the item-level transaction data associated with the outing may be gathered for storage (operation 504). As described above, this data may be received from multiple sources, such as the consumer client system 102, the merchant system 240, the payment provider system 242, and/or the merchant POS system 244. The transaction data may then be stored in the transaction detail data storage 214 as transaction data 228 (operation 506). Further, the transaction data mapper 286 may map the stored transaction data 228 to more standardized or mapped transaction data 226 in the mapped transaction detail data storage 212.

The offer tracking/verification engine 290 may then determine whether the newly purchased items are associated with any previous offers accepted by the consumer (operation 508). In one example, the transaction and offer system 200 may expect a consumer to explicitly accept an offer (such as by way of a user interface facilitated by the consumer agent 104 executing on the consumer client system 102) that the consumer previously received from the system 200 prior to redeeming the offer. In other implementations, an explicit acceptance of an offer may not be necessary, as performing the necessary actions to redeem the offer may constitute an implicit acceptance of the offer.

If the newly purchased items are associated with a previously accepted offer (operation 508), the offer tracking/verification engine 290 may then process the data identifying the items purchased, and possibly other data related to the purchase, to determine the reward or benefit to be provided to the consumer (operation 510), as discussed earlier. For example, the identity of the retailer or information describing the consumer's attributes may also be considered in determining the consumer's eligibility for the benefit, as described in the offer terms of the offer. The offer tracking/verification engine 290 may then employ the user account engine 292 to provide the benefit to the consumer (operation 512), such as by way of crediting an account of the consumer.

After the providing of the benefit (operation 512), or if the newly purchased items do not correspond with previously accepted offers (operation 508), the offer matching engine 138 may then identify offers that match with, or are triggered by, the newly purchased items (operation 514), as described above. Any offers triggered by the new purchases made by the consumer may then be delivered to the consumer via the offer delivery engine (operation 516). After delivery of such an offer, the consumer may accept the offer (operation 518), either explicitly or implicitly, to render the offer redeemable.

As shown in FIG. 5, the various operations of the method 500 are performed each time item-level transaction data for a shopping outing, such as at a physical store or online outlet, are received at the transaction and offer system 200. However, the timing of the operations of the method 500 may be different in other embodiments. For example, the set of operations shown in FIG. 5 may be performed in a continual or repetitive manner regardless of the timing of the reception of the item-level transaction data into the system 200.

FIG. 6 is a flow diagram illustrating an example method 600 of transaction data retrieval and processing, as is described above. Once a shopping outing has been completed (operation 602), item-level transaction data may be provided to the transaction and offer system 200 in a number of forms. As shown in FIG. 6, these forms include, for example, a paper receipt 610, merchant item-level transaction data 620, and an electronic receipt 630 provided by a payment provider system. However, other forms of item-level transaction data may be provided in other examples.

If the transaction data is presented in the form of a paper receipt 610, the consumer client system 102, in conjunction with the transaction detail data aggregation system 256, may capture or receive an electronic image of the paper receipt 610 (operation 612), process the electronic image to extract the item-level transaction data represented in the image (operation 614), and store the electronic image and the extracted data (operation 616) as transaction data 228 in the transaction detail data storage 214 via the transaction detail data aggregation system 256. In this example, the electronic image may be stored to so that a human comparison of the electronic image and the extracted data may be monitored for accuracy, and so that processing of the image may be attempted again to more accurately extract the transaction data. In other implementations, only the extracted data may be stored. More detailed examples of the imaging of the paper receipt and the processing of the resulting electronic images are provided below in conjunction with FIGS. 7A and 7B.

If the item-level transaction data is provided in the form of merchant item-level data 620, such as by way of a merchant system 240 website (e.g., via data interface 250) or via a merchant POS system 244 (e.g., via data interface 254), the transaction detail web data scraper 260 or the transaction detail data collector 264 may receive the transaction item-level data (operation 622) and forward the data via the transaction detail data acquisition API 266 to the transaction detail data aggregation system 256 for storage (operation 624) as transaction data 228 in the transaction detail data storage 214. In some examples, the transaction data may be processed to arrange the data in a format understood by the transaction detail data aggregation system 256.

If the transaction data is provided as an electronic receipt 630, such as what may be transmitted from a payment provider system 242, the transaction detail data collector 262 may receive the electronic receipt (operation 632), process the electronic receipt to extract the transaction data (operation 634), and store the electronic receipt and the extracted data (operation 636) as transaction data 228 in the transaction detail data storage 214 by way of the transaction detail data collector 262, the transaction detail data acquisition API 266, and the transaction detail data aggregation system 256. Similar to the paper receipt 610 example, the extraction process may introduce errors into the transaction, and storing the electronic receipt 630 may aid in comparing the extracted data with the original receipt and in generating new extracted data. In one example, the electronic receipt 630 may include image data that is processed to extract the item-level transaction data.

The transaction data mapper 286 may map or convert the transaction data 228 stored in the transaction detail data storage 214 to a uniform data format (operation 640) by using reference product data provided by one or more consumer client systems 102 or reference product data storage systems 280, 284, 285 as explicated above. The resulting mapped transaction data 226 may then be stored in the mapped transaction detail data storage 212 (operation 642), where the offer matching engine 138 may access the mapped transaction data 226 for offer matching and redemption purposes.

FIGS. 7A and 7B are flow diagrams of example methods 700A, 700B of capturing and processing an image of a paper receipt 610, and processing and storing the resulting transaction data. More specifically, FIG. 7A depicts the method 700A, in which the processing of the image data occurs primarily in the transaction and offer system 200, while FIG. 7B illustrates the method 700B, in which the processing of the image data occurs primarily in the consumer client system 102 that captured the image. In the particular method 700A of FIG. 7A, an electronic image of the paper receipt 610 is captured or previewed (operation 702).

After capture of the image (operation 702), the consumer client system 102 may analyze one or more aspects of the quality of the image (operation 704). In some implementations, the consumer client system 102 may identify problems with the image that may be corrected by a second image capture operation. Such conditions may include, but are not limited to, inadequate lighting, lack of focus or sharpness, improper alignment of the camera or other imaging device provided by the consumer client system 102, and image distortion. Further, the analysis of the image may be enhanced using data provided by orientation sensors or other components of the consumer client system 102.

Based on the analysis of the image (operation 704), the consumer client system 102 may determine that another image of the paper receipt 610 should be captured (operation 702), in which case the consumer client system 102 may provided guidance to the consumer via a user interface of the consumer client system 102 regarding additional lighting, camera orientation relative to the paper receipt 610, and so on. If, instead, the consumer client system 102 determines that the previously captured image is of acceptable quality, the consumer client system 102 may then transmit the image (operation 706), possibly along with one or more parameters describing the image and/or camera settings employed to capture the image, as image 740 via the communication network 114 to server platform 120 hosting the transaction and offer system 200.

After being received at the server platform 120 via the consumer API 246, the transaction and offer system 200 may store the image 740 (operation 712). In one example, the consumer API 246 may store the image and perform various other operations discussed below. The transaction and offer system 200 may then binarize the image (operation 714). More specifically, if the image 740 is a color or grayscale image, the transaction and offer system 200 may then convert the image 740 into a binary image, in which each pixel may be, for example, black or white. Two examples of an algorithm useful for binarizing an image is the Local Adaptive Niblack Algorithm and Sauvola's Algorithm, which is a modification of the Niblack approach useful for images with uneven lighting or a lightly textured background. However, other methods or algorithms for binarizing an image may also be employed in other embodiments in order to prepare the image for subsequent processing.

After the image is binarized (operation 714), significant skew or misalignment of the image relative to edges or borders of the image may be detected and compensated (operation 716) to ensure the image is properly aligned for subsequent processing. In one example, the transaction and offer system 200 may identify text lines and/or baselines in the image, and then rotate the image, if necessary, based on those lines.

After any skew detection and/or compensation is performed (operation 716), the transaction and offer system 200 may then perform optical character recognition (OCR) on the binarized and/or de-skewed image (operation 718). In this operation, text or characters represented in the image may be extracted based on one or more OCR algorithms currently available.

The text generated by OCR (operation 718) may then be processed to extract the item-level transaction data represented on the paper receipt 610 (operation 720). For example, the transaction and offer system 200 may parse the generated text or characters, looking for specific types of data, such as UPCs, keywords, and so on, in order to generate the item-level transaction data. Thereafter, the transaction and offer system 200, via the transaction data aggregation system 256, may store the item-level transaction data as transaction data 228 in the transaction detail data storage 214.

As discussed above, the transaction data mapper 286 may then map the transaction data 228 from the transaction detail data storage 214 to a unified format (operation 724) using the reference product data storage systems 280, 284, 285. The transaction data mapper 286 may then store the resulting mapped transaction data 226 (operation 726) in the mapped transaction detail data storage 212. In some examples, the transaction and offer system 200 may then be transmitted as mapped item-level data 750 via the network 114 to the consumer client system 102 (operation 728), which may then store the mapped item-level data 750.

In FIG. 7B, the method 700B employs most of the same basic operations (e.g., operations 702, 704, 712, 714, 716, 718, 720, 722, 724, 726, and 728) as employed in the method 700A of FIG. 7A to capture, binarize, and/or de-skew the image, extract the item-level transaction data from the image via OCR, and map the resulting data to a unified format. In this method 700B, however, at least the binarization (operation 714), de-skewing (operation 716), OCR (operation 718), and extraction of the item-level transaction data (operation 720) occur in the consumer client system 102 instead of the server platform 120. Only then may the extracted data, possibly in conjunction with the image and parameters related thereto, be transmitted via the network 114 to the server platform 120 (operation 760) as extracted data 765.

In some examples, the decision as to whether method 700A or method 700B is implemented may depend on the processing capabilities and capacities of both the consumer client system 102 and the server platform 120. Further, the server platform 120 may decide whether a particular consumer client system 102 performs one or more of the binarization, de-skew, OCR, and extraction operations (operations 714-720) on a client-by-client basis in view of the individual capabilities of each consumer client system 102 in some embodiments. In some instances in which an OCR result (e.g., the text generated by the OCR operation via operation 718 or the extracted item-level transaction data produced via operation 720) is deemed to be lacking in reliability, a review of the paper receipt 610 and subsequent manual entry of the associated item-level transaction data and other receipt data by a human may aid in the capture of information. Further, a human reviewer may be presented with a complete or partial image of the receipt, as this may aid efficiency of review and data entry, as well as possibly enhance consumer privacy.

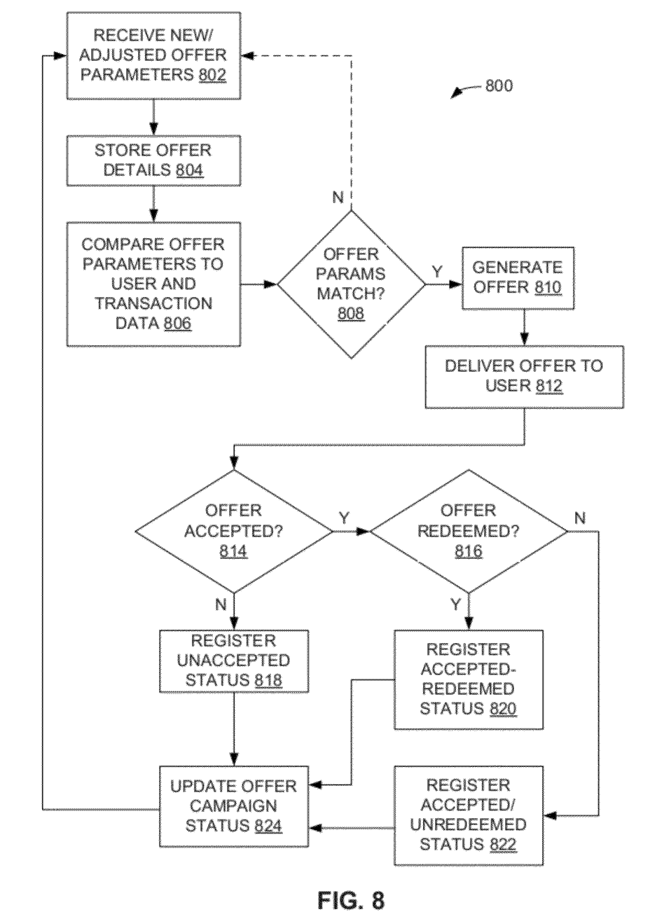

FIG. 8 is flow diagram of an example method 800 of offer matching, generation, tracking, and redemption in the transaction and offer system 200. In the method 800, the offer entry/management system 314 may receive new offers 300 (operation 802) from the offer client system 106 via the offer UI 202 and the offer API 204. The offer entry/management system 314 may also store the received offers 300 (operation 804) as offer data 222 in the offer data storage 208. The offer matching engine 138 may then compare the parameters of the offer data 222 from the offer data storage 208 to either or both of the mapped transaction data 226 from the mapped transaction detail data storage 212 and the user data 224 from the user data storage 210 (operation 806), as discussed above.

If the offer parameters do not match the user data 224 and/or the mapped transaction data 226 (operation 808) such that at least one user or consumer is qualified to receive the offer, as determined by the offer tracking/verification engine 290, the offer client system 106 may modify or adjust the offer parameters (operation 802) and store them (operation 804) before the offer matching engine 138 continues to compare the offer parameters against the mapped transaction data 226 and/or the user data 224 (operation 806). If, instead, the offer parameters match the user data 224 and/or the mapped transaction data 226 (operation 808) such that at least one user or consumer is qualified to receive the offer, the offer delivery engine 140 may then generate a proposed offer 232 for the at least one user or consumer (operation 810) and deliver the proposed offer 232 (operation 812) via the consumer API 246 to the corresponding consumer client systems 102.

If a targeted consumer does not accept the proposed offer 232 (operation 814), the offer tracking/verification engine 290 may register the unaccepted status of the proposed offer 232 (operation 818) and update a campaign status associated with the proposed offer 232 (operation 824) accordingly. Instead, if the targeted consumer accepts the proposed offer 232 (operation 814), the offer tracking/verification engine 290 may then determine if the proposed offer 232 has been redeemed by the consumer (operation 816), such as by detecting whether the consumer has performed according to the terms of the offer 232. If so, the offer tracking/verification engine 290 may register the proposed offer 232 as accepted and redeemed (operation 820) and update the offer campaign status accordingly (operation 824). Otherwise, the offer tracking/verification engine 290 may register the proposed offer 232 as accepted but unredeemed (operation 822) and update the offer campaign status similarly (operation 824). Based on the campaign status that prevails at any particular time, the manufacturer, retailer, or other entity may modify the offer parameters of the offer (operation 802) in order to increase the success of the offer campaign.

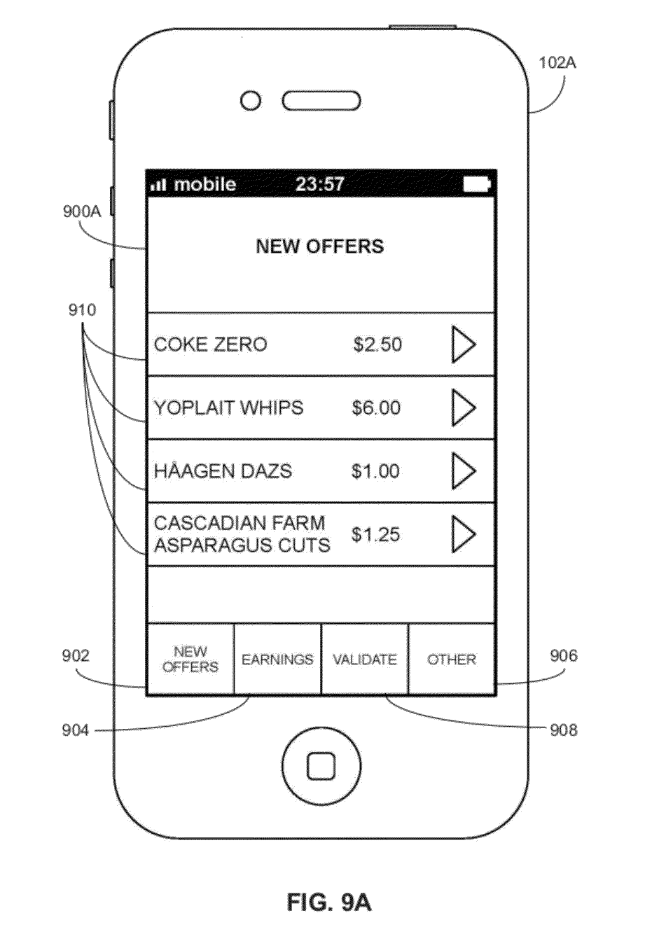

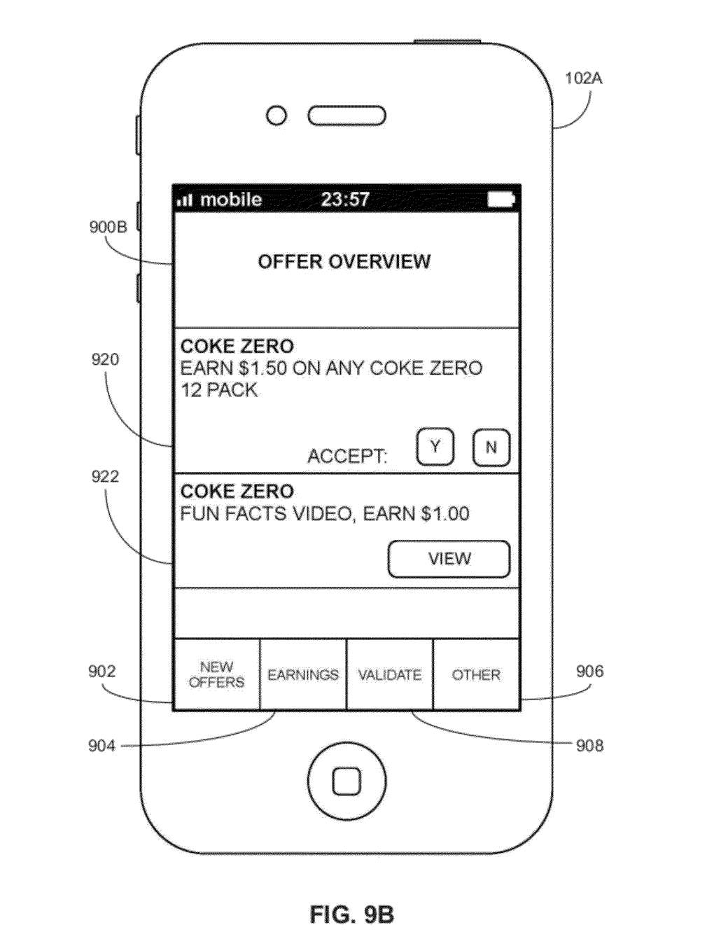

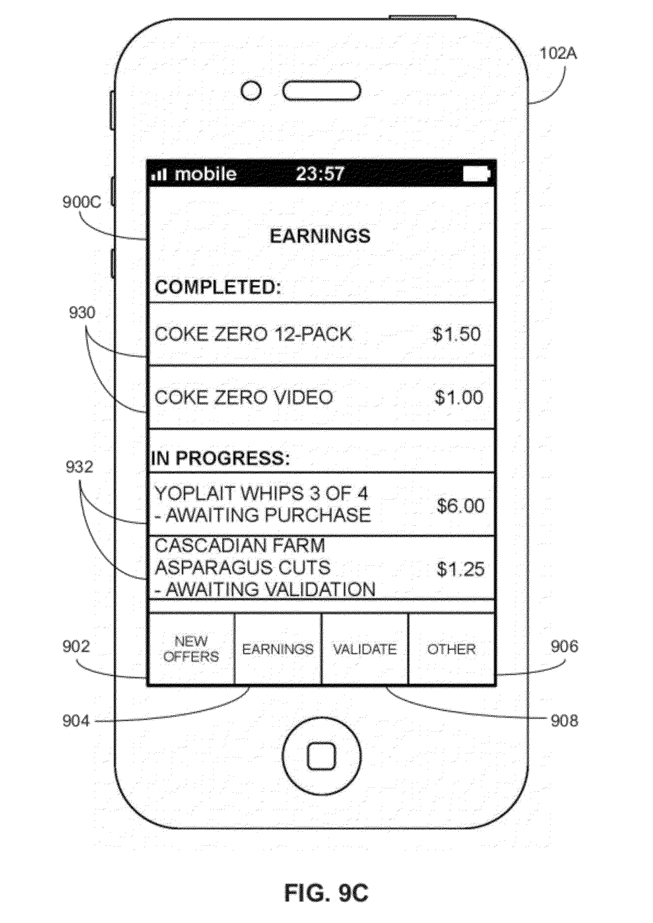

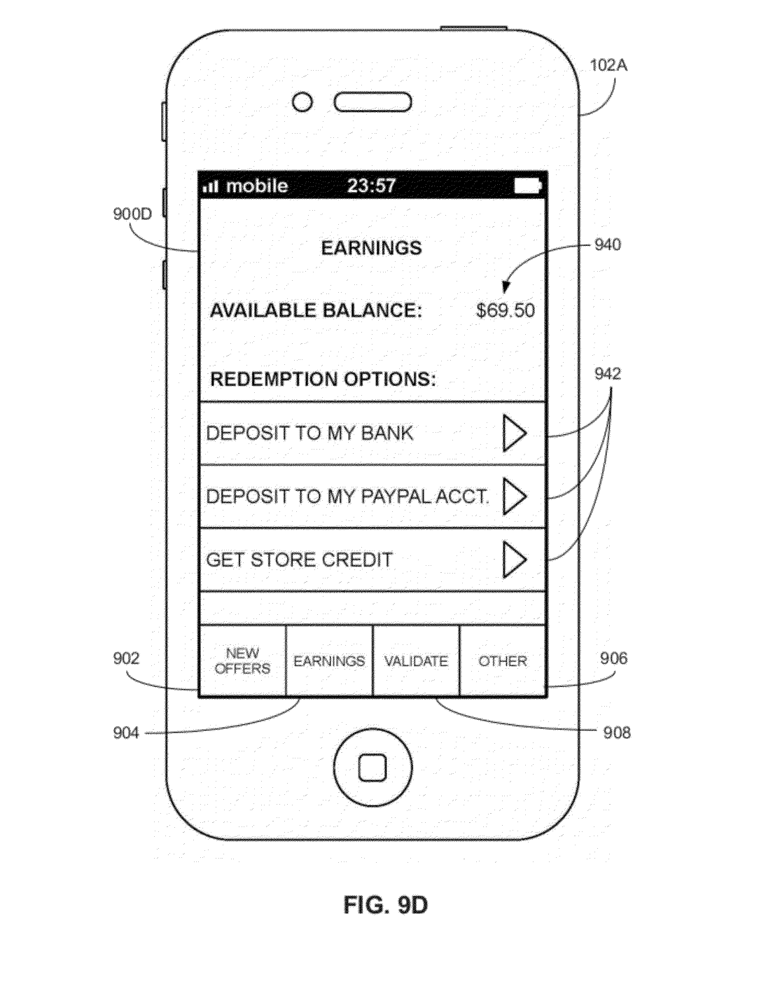

FIGS. 9A, 9B, 9C, and 9D are graphical representations of an example user interface provided on the consumer client system 102 of FIG. 1. In this example, the consumer client system 102 is a smart phone 102A executing a mobile application (e.g., the consumer agent 104 of FIG. 1) and employing a touch-sensitive display. In other embodiments, similar information illustrated in FIGS. 9A through 9D may be presented in a different format via software executing on a desktop, laptop, or tablet computer serving as the consumer client system 102. In each of FIGS. 9A through 9D, the mobile application displays a set of menu selection buttons 902-908. In this example, the application provides a “new offers” button 902, an “earnings” button 904, a “validate” button 908, and an “other” button 906. Generally, the new offers button 902 may allow the consumer to view any new offers provided by the transaction and offer system 200. The earnings button 904 may provide the consumer with a list of offers redeemed with associated earnings, options for how the earnings are to be delivered to the consumer, and so on. The validate button 908 may provide a mechanism whereby a user may validate item-level transaction data retrieved from paper receipts, electronic receipts, and other sources described above for processing in the transaction and offer system 200. The consumer may access other functions or operations via the other button 206. While FIGS. 9A through 9D provide one example interface scheme for the consumer client device 102A, many others are possible.

FIG. 9A depicts an example of a new offers user interface 900A for display of new offers to the consumer, presented in one example in response to consumer activation of the new offers button 902. The new offers interface 900A displays a number of new offers 910 directed to the consumer associated with the consumer client device 102A, wherein each offer 910 provides a corresponding offer product (e.g., Coke® Zero) and a total amount that the consumer may earn (e.g., $2.50 for Coke® Zero) in response to performing according to the terms of the offer.

In FIG. 9A, consumer activation of the topmost (Coke® Zero) new offer 910 may result in the user interface 900B of FIG. 9B being displayed to the user. More specifically, the user interface 900B presents two separate offers 920, 922 associated with Coke® Zero. The upper offer 920 is an offer for the consumer to earn $1.50 on any 12-pack of Coke® Zero. To accept or decline the offer 920, the consumer need only activate the corresponding “yes” or “no” button provided in the interface 900B. The second offer 922 informs the consumer of the ability to earn $1.00 for viewing a “fun facts” video that imparts some information about the offer product. To activate this offer 922, the consumer may activate the “view” button provided, which may then cause the video to be transmitted to, and displayed on, the consumer client device 102A. An offer may depend on the extent of engagement a user has demonstrated in the past, either with the system 100 as a whole, a particular brand, a type of offer, or in other ways. For example, a user who demonstrated a greater level of engagement may get an offer of $1.25 (instead of $1.00) for watching the same “fun facts” video mentioned above.

Presuming the consumer has redeemed both Coke® Zero offers presented in FIG. 9B, and the consumer then activates the earnings button 904, the application may present a user interface 900C that displays both completed Coke® Zero offers 930 and any offers-in-progress 932 accepted by the consumer. The completed offers 930 may indicate the name or description of the offer and the amount earned by the consumer for completing those offers. The offers-in-progress 932 may indicate the products involved, the value of the offer upon completion, the progress the consumer has made in completing the offer (e.g., three or four purchases made), and/or the remaining actions to be taken by the consumer to complete the offer (e.g., “awaiting purchase” or “awaiting validation” of the purchase).

Shown in FIG. 9D, the mobile application may also provide a second user interface 900D in response to the consumer activating the earnings button 904. In one example, the consumer may access the second interface 900D by dragging the first interface 900C of FIG. 9C up, down, or to a side of the touch screen of the mobile device 102A. The second interface 900D may present to the consumer the earned available balance 940 that may be forwarded to the consumer. The second interface 900D may also present one or more redemption options 942 (e.g., “deposit to my bank,” “get store credit,” etc.), any of which the consumer may select to determine how the funds or credit are to be delivered to the consumer.

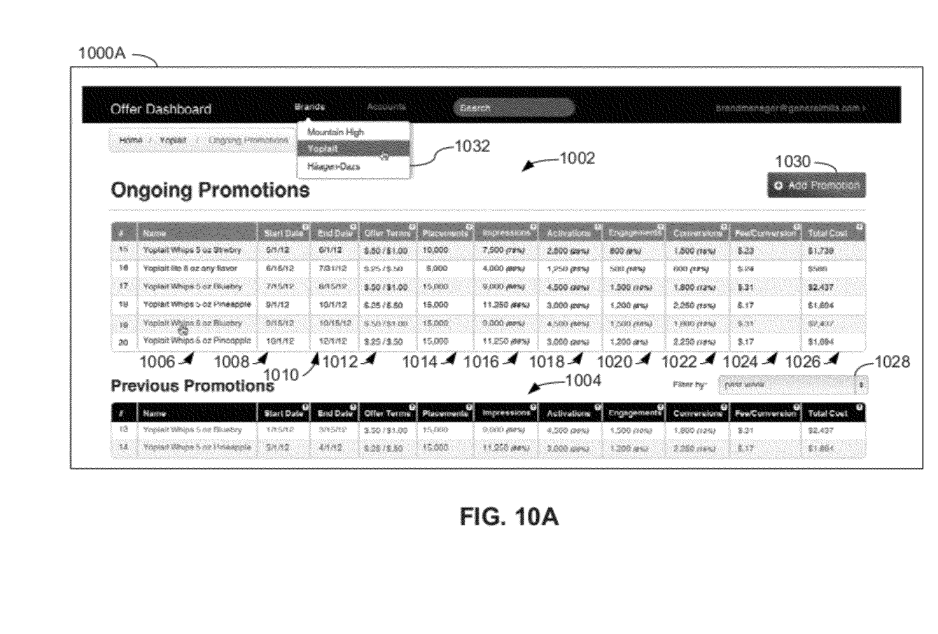

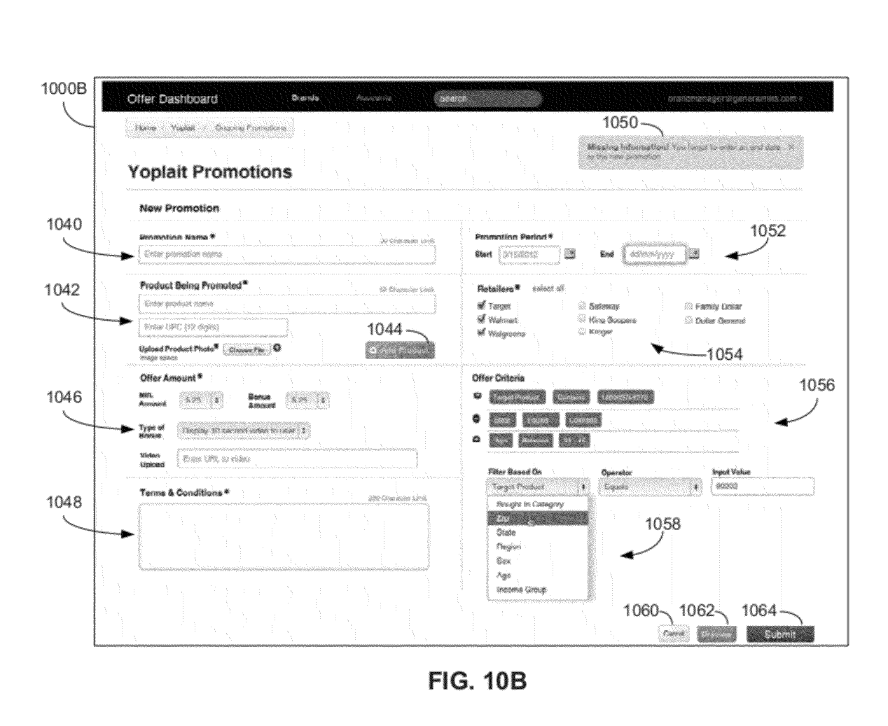

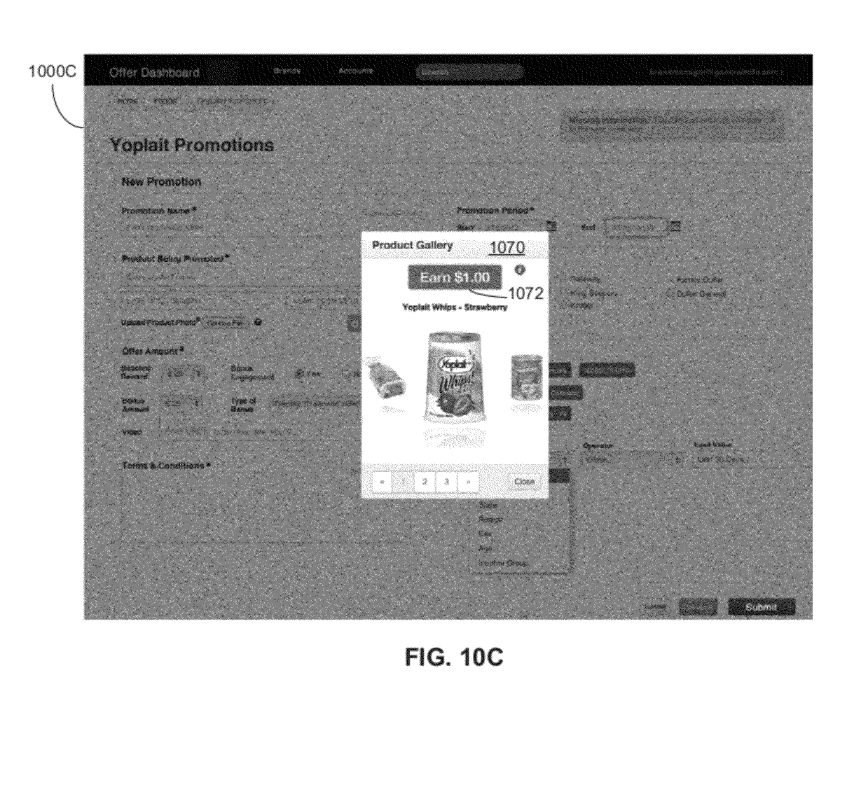

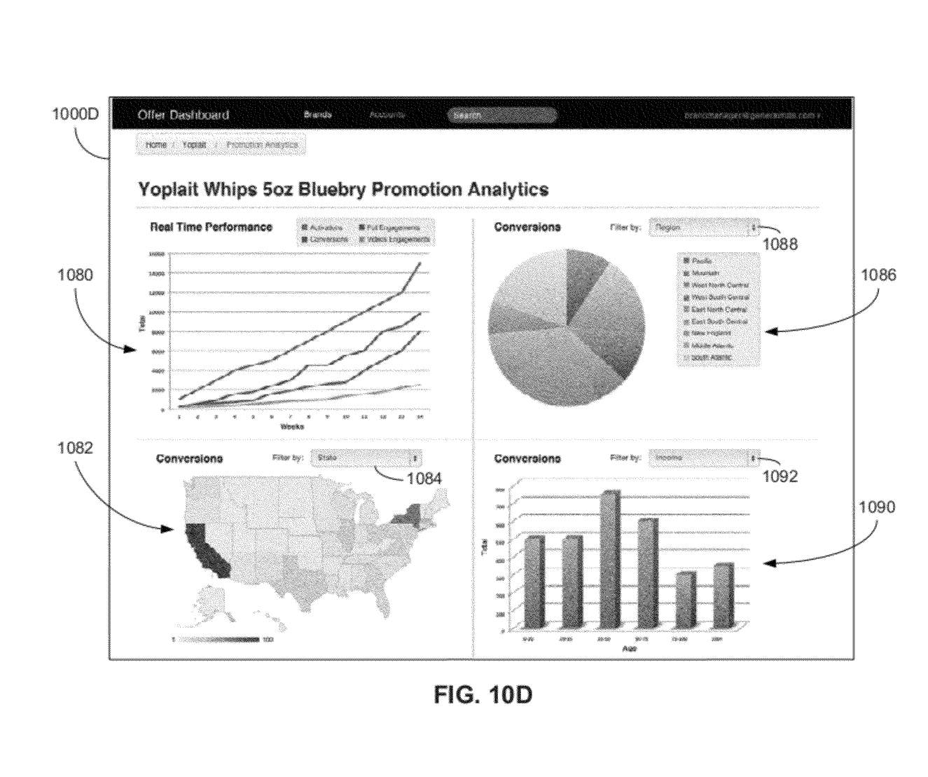

FIGS. 10A, 10B, 10C, and 10D are graphical representations of an example user interface provided on an offer provider client system of FIG. 1. In this particular example, the offer provider interface is in the form of an offer “dashboard” viewable on a typical desktop or laptop computer system, the dashboard providing the user representing the offer provider access to the transaction and offer system 200 for defining and previewing specific offers, as well as monitoring the progress of offers and related promotional campaigns.

In FIG. 10A, a user interface 1000A provides the user with an overview of both ongoing (in-progress) offer promotions 1002 and previous (expired) promotions 1004. In one example, the user can specify the scope of the promotions being displayed by way of a pull-down menu 1032, from which the user may select a particular product or brand. The interface 1000A may then present several metrics for each promotion 1002, 1004 corresponding to the selected product or brand. The metrics may include, in one example, a name 1006 of the product or brand, a start date 1008 and an end date 1010 for the offer, terms 1012 of the offer, the number of placements 1014 for the offer (e.g., the number of consumers to whom the offer was delivered), and a number of engagements or interactions 1016, 1018, 1020, 1022 at a number of different of possible engagement levels, as well as a percentage of those engagements relative to the number of placements. In this example, the dashboard presents the number of impressions 1016 of the offer (e.g., some level of interaction with the offer, such as viewing, investigation, rejection, etc.), the number of activations 1018 (e.g., the number of acceptances of the offer), the number of engagements 1020 of the offer (e.g., at least one product purchased that is required in order to complete the offer), and the number of conversions 1022 (e.g., the number of offers that were successfully completed by a consumer). The user interface 1000A may also specify a fee 1024 for each conversion and the total cost 1026 of the promotion or campaign.

Also in FIG. 10A, the user may filter the previous promotions 1004 displayed via a filter selection 1028 that may filter the displayed promotions that ended during a desired time period (e.g., the past week or the past month). In other embodiments, the previous promotions 1004 may be filtered and/or ranked according to other criteria, such as conversion percentage, total cost, and so on.

To add a new offer or promotion via the user interface 1000A, the user may activate an “add promotion” button 1030, to which the transaction and offer system 200 may respond by presenting an offer entry user interface 1000B depicted in FIG. 10B. In one embodiment, the offer entry user interface 1000B may be tailored to the particular product or brand selected in the user interface 1000A of FIG. 10A. As shown in FIG. 10B, the user may specify several aspects or parameters for the offer, such as the promotion name 1040 and the promoted product 1042. In this implementation, multiple products may be added to the offer by way of an “add product” button 1044. The user may also specify an offer amount 1046, including minimum and bonus amounts, the type of activity for the consumer to complete to earn the bonus (e.g., watch a ten-second video), and other information related to the type of bonus. The user may also specify any other terms and conditions of the offer in a text box 1048, as well as the promotion period 1052, the retailers 1054 through which the purchase is to occur for completing the offer, and the specific offer criteria 1056 for delivering the offer to a user.

As discussed above, the offer criteria 1056 may specify the triggering or target product, various characteristics of the target consumer (such as location and age), and other aspects. As illustrated in FIG. 10B, each of the offer criteria 1056 may be specified by one or more pull-down menus 1058. In this case, the user is in the process of indicating that the target consumer lives in ZIP Code 80202. The user may also remove or delete previously specified criteria 1056 via the “minus” buttons displayed to the left of each offer criterion 1056.

During specification of the offer, the user may cancel out of the offer via a cancel button 1060, or submit a finished offer via a submit button 1064. Current offers may also be modified in a similar fashion in some examples. Prior to submission of the offer, the user may also activate the preview button 1062 of interface 1000B to view a preview display of the offer as it will be presented to a targeted consumer. An example of this offer display preview 1070 is shown in FIG. 10C in the context of user interface 1000C. In the particular example, the offer entry user interface 1000B is “grayed-out,” and the offer preview display 1070 is presented to the user. The display of the offer may include a photo or graphic of the actual product, a description of the product, and an activation or acceptance button 1072 that allows the consumer to accept the offer.

FIG. 10D illustrates a promotion analytics user interface 1000D that allows the user representing a manufacturer or merchant to view several metrics or aspects of an ongoing promotion. In the specific example of FIG. 10D, the promotion analytics user interface 1000D provides a real-time performance graph 1080 that displays the number of activations, poll engagements, video engagements, and conversions of the offer. Also provided may be a map 1082 of a comparison of a number of relative conversions distinguished by state. The user may also employ a filter selector 1084 of the interface 1000D to display the number of conversions relative to consumer demographics, geographical areas, or other parameters. The interface 1000D may also provide a pie chart 1086 that displays the number of conversions by region (or by other parameters selectable via a filter selector 1088), as well as a bar graph 1090 depicting the number of conversions according to consumer income (or by other characteristics selected via a filter selector 1092). Other ways of presenting conversions or other aspects of an ongoing (or previous) offer aside from graphs, maps, pie charts, and bar graphs may be employed in the promotion analytics user interface 1000D in other implementations.

In view of at least some of the embodiments described above, the transaction and offer system 200 may target purchase offers to a particular consumer or group of consumers based on item-level transaction data that may be retrieved from a number of sources, such as consumers, retailers, payment providers, and the like. Such a system may make a promotional campaign involving the purchase offers more successful and efficient, thus benefiting consumers, manufacturers, and merchants alike. Also, by providing timely access to offer acceptances and/or redemptions, the entity providing the offers may alter the various parameters of the offers quickly to further the success of the promotion. Additionally, as the item-level transaction data may describe consumer transactions across multiple retailers or merchants, an entity employing the transaction and offer system 200 may employ and experiment with a variety of offer strategies for maintaining current customers, attracting customers that are new to the market involved, and enticing customers away from competitors.

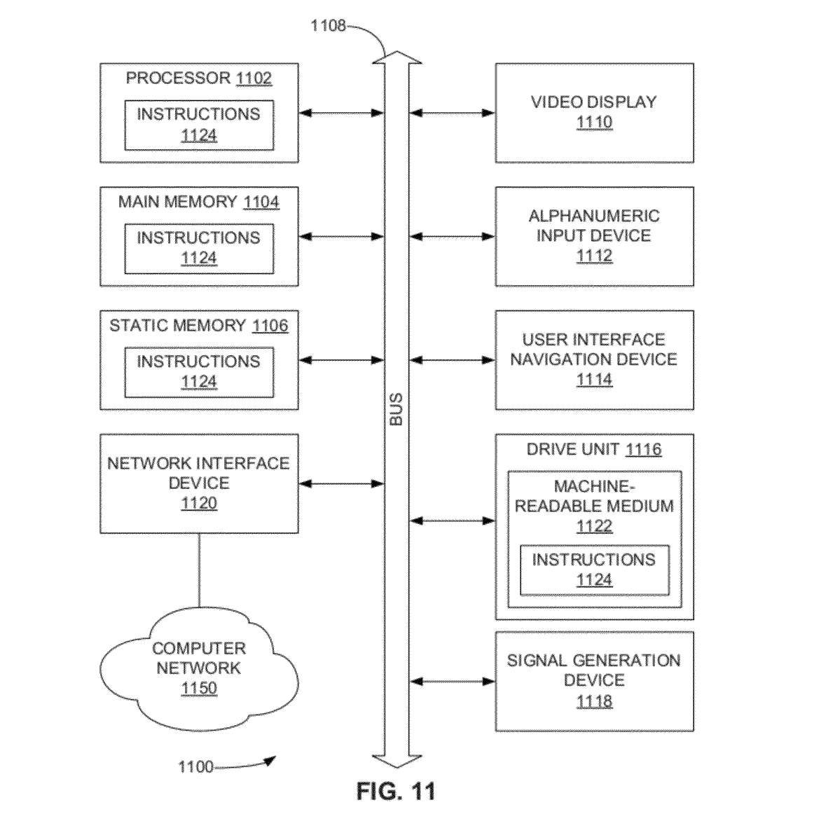

FIG. 11 depicts a block diagram of a machine in the example form of a processing system 1100 within which may be executed a set of instructions 1124 for causing the machine to perform any one or more of the methodologies discussed herein. More specifically, the processing system 1100 may serve as any of the client systems 102, 106, 110, the server platform 120, or any portion thereof, as illustrated in FIG. 1. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 1100 includes a processor 1102 (e.g., a central processing unit (CPU), a graphics processing unit (GPU), or both), a main memory 1104 (e.g., random access memory), and static memory 1106 (e.g., static random-access memory), which communicate with each other via bus 1108. The processing system 1100 may further include video display unit 1110 (e.g., a plasma display, a liquid crystal display (LCD), or a cathode ray tube (CRT)). The processing system 1100 also includes an alphanumeric input device 1112 (e.g., a keyboard), a user interface (UI) navigation device 1114 (e.g., a mouse), a disk drive unit 1116, a signal generation device 1118 (e.g., a speaker), and a network interface device 1120.

The disk drive unit 1116 (a type of non-volatile memory storage) includes a machine-readable medium 1122 on which is stored one or more sets of data structures and instructions 1124 (e.g., software) embodying or utilized by any one or more of the methodologies or functions described herein. The data structures and instructions 1124 may also reside, completely or at least partially, within the main memory 1104, the static memory 1106, and/or within the processor 1102 during execution thereof by processing system 1100, with the main memory 1104 and processor 1102 also constituting machine-readable, tangible media.

The data structures and instructions 1124 may further be transmitted or received over a computer network 1150 via network interface device 1120 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 1100) or one or more hardware modules of a computer system (e.g., a processor 1102 or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 1102 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor 1102 that is configured using software, the general-purpose processor 1102 may be configured as respective different hardware modules at different times. Software may accordingly configure a processor 1102, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 1102 that are temporarily configured (e.g., by software) or permanently configured to perform the relevant operations. Whether temporarily or permanently configured, such processors 1102 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 1102 or processor-implemented modules. The performance of certain of the operations may be distributed among the one or more processors 1102, not only residing within a single machine but deployed across a number of machines. In some example embodiments, the processors 1102 may be located in a single location (e.g., within a home environment, within an office environment, or as a server farm), while in other embodiments, the processors 1102 may be distributed across a number of locations.

The system 100 of FIG. 1 and the various components and operations discussed in conjunction with system 100, possibly along with additional modules and databases, may provide functionality beyond that discussed above for the benefit of the various parties, such as the consumer, manufacturer, and/or merchant. For example, the system 100 may allow a user to create a comprehensive personal inventory of the items they have purchased. This inventory may be located in data storage 150 of the system 100 and/or the consumer client system 102 of the user. By querying this data, the consumer may extract useful information relating to products that the consumer has purchased. Users may then optimize future purchase decisions by cross-referencing inventory data about their purchased goods with other data, such as, for example, product-specific pricing information, applicable discounts by product and by store, store locations, and product inventories. In one example, the inventory data may include, but are not limited to, the exact make, model number, or product code of each item purchased, the quantity of item purchased, and the price of each item purchased. Additional information associated with the overall purchase or outing, such as the date and location of the transaction, may also be recorded and stored. In some examples, such information may be presented to the user on a computer or mobile device via a personalized webpage, mobile application, or other data presentation mechanism.

In one embodiment, the consumer may create a comprehensive electronic shopping list based on the personal collected item-level purchase data of the consumer described above, as well as from item-level purchase data of other consumers, such as friends, relatives, referrers of products, and others. In addition, the consumer may specify (either manually or automatically) one or more products from the item-level purchase data of the consumer or others for subsequent purchase. In one example, the consumer may query the item-level purchase data to determine where the product was purchased, how much was paid, and so on. Such queries may be based on a UPC, SKU, item description, and/or other means.

The system 100 may then analyze the resulting shopping list, which may be termed “a basket of goods,” as mentioned above, to determine where to buy the basket of goods at the lowest overall cost. This analysis may include, for example, comparing prevailing prices at physical stores in the vicinity of the consumer as well as prices of the products available through online retailers. The system 100 may optimize the basket based on the analysis of some or all of the above criteria, thus determining from which online and/or offline stores each product should be purchased to reduce overall cost. In another embodiment, the user or consumer may also choose to optimize the basket of goods based on one or more non-price variables, such as, for example, substitute products available for the desired items in the basket, the distance to travel between the home of the consumer and the various physical stores, the number of physical stores involved in the purchase of the items in the basket, the amount and/or cost of fuel required to travel to or between the physical stores, any delivery charges imposed for purchases from online or offline stores, estimated time until delivery of the purchases, and so on. In one example, the consumer may suggest or specify any potential substitutes for the items listed in the basket, or the system 100 may suggest such alternatives, either automatically or under the guidance of the consumer. In addition, these various criteria for optimizing the basket of goods may be weighted by the system 100 and/or the consumer.

In a related example, the system 100 may retrieve, store, and update data describing fuel costs and consumption for each consumer or for one or more geographical regions. This system 100 may employ this data to determine the costs of travel between the home of the consumer and one or more stores. The system 100 may then use these costs to determine overall costs incurred by the consumer in shopping at one store versus another, whether at a physical store or an online retailer.

In one example, the consumer may choose to split the shopping list or basket into sublists or subbaskets, one per physical or online store, using the above criteria for pricing the overall set of goods at the lowest total cost. Further, the system 100 may present more than one possible set of subbaskets, allowing the consumer to choose one for implementation. Additionally, the system 100 may allow the user to “click through” a particular basket or subbasket for an online retailer, thus bringing the consumer to the associated vendor's checkout page with the items of the basket or subbasket already populated therein and ready for purchase. In examples in which more than one physical store is suggested for purchasing the basket of goods, the stores selected may be based on the home location of the consumer or the present location of the consumer. In addition, the system 100 may present to the consumer the shortest and/or most efficient route to navigate between the physical stores based on the current geographic location of the user and the various stores, possible routes between these locations, estimated travel time between the locations based on current and/or future traffic conditions, and so forth.

In another implementation, the system 100 may store and maintain data describing individual stores, including traditional retail stores, mail-order merchants, online vendors, and the like. This data may include, for example, the physical location, mailing address, website address, and other contact information regarding each merchant. The data may also include information about the inventory of items held by the store, such as a list of products available for purchase, identifying information for each product (e.g., UPC, brief description, category designation, and so on), the volume or quantity in which each product is sold, the name of the manufacturer or producer of the product, the cost of each product, coupons or other promotional offers applicable to each product, delivery and handling charges for each product, delivery time for each product, and whether each product is currently in stock. The system 100 may retrieve such information periodically, either electronically or manually, from the various retailers to ensure this data is updated in near-real-time. Another source of such data is the consumer item-level transaction data that the system 100 retrieves for each consumer associated with the system 100. The system 100 may also compare the various sources of information and the transaction or retrieval times associated therewith to determine the most accurate pricing currently available.

In another implementation, by recording and analyzing the purchase history of a consumer, the system 100 may determine at what intervals the stock of any particular good previously purchased by the consumer should be repurchased and remind or alert the consumer of the need to restock such goods or items. These items may be periodically aggregated into a virtual basket of goods for the consumer to purchase, possibly according to a schedule that is generated by the system 100 and/or the consumer.

In another embodiment, the system may analyze data about past and upcoming item-level purchases to provide a summary or more detailed analysis of the personal finances of the consumers, including budgets, spending habits and so on for more precise allocation of expenses among a number of product categories. For example, instead of allocating to general categories, such as “household” or “groceries,” the system 100 may facilitate the definition and use of more specific categories, such as “frozen foods,” “produce,” “soft drinks,” and the like. The consumer and/or the system 100 may define these categories, depending on the implementation. Additionally, the consumer may assign and/or revise the various items to the categories, and/or the system 100 may perform those operations automatically. Via the analysis of the purchases relative to these categories, a consumer may identify personal spending habits and ways to save money through modifications in purchasing habits or patterns, such as by purchasing close substitutes, by purchasing more of the products while on sale, and so on. The system 100 may present results of the analysis to the consumer by way of tables, charts, graphs, and the like. This data may also be shared with other personal finance applications in some examples.

In some implementations, the system 100 may present a consumer with visual displays, possibly including games to be played by the consumer, that reflect the status of the consumer relative to other consumers, the progress of the consumer toward completion of one or more promotional campaigns, past earnings, and other metrics involving the system 100. Such information may compare consumers that are related or connected via a social network or other means, consumers of a specific geographic location or area, consumers of a particular age, income, or demographic group, and the like. Such comparisons may be displayed via a ranking or score associated with the consumer relative to other consumers.

The system 100 may also permit a consumer to electronically transmit shopping lists or virtual baskets of items, or information on individual products that the consumer has previously purchased, to their friends and other social or business contacts. In another example, the system 100 may enable the consumer to electronically transmit recommendations of products, baskets, and/or lists of products to friends and other contacts, or view product ratings generated by themselves or others before deciding whether to purchase the same or similar products. Such transmissions of recommendations may be provided via a webpage, email, social network sites, and the like. If the products listed in the recommendation are available via an online retailer, the recommendation may include the identity of the retailer. The recipient of the recommendation may also “click through” the recommendation to access the retailer providing the products. If the products are available at a physical store, the recipient may receive the name of the store, along with directions and other information to aid the recipient in navigating to the store. In another embodiment, the system 100 may permit users who have received a product recommendation to add that item to a personal virtual basket of goods, or import the recommended product into their own inventory data as a “wish list” item.

In other examples, the system 100 may enable consumers to transmit messages containing feedback or reviews to manufacturers and/or retailers about the products they have purchased from within the system 100 or using a computerized interface of another delivery system. This feedback may also be made available to other consumers using the system 100, such as via a website (e.g., a website associated with the consumer providing the feedback), mobile application, or other mechanism. Such information may also include where the products were purchased, the prices at which the products were obtained, and the like. In some examples, the system 100 may target one or consumer with polls or questionnaires about shopping habits, a product previously purchased, consumer perceptions concerning a product, and the like. Moreover, the system 100 may provide cash or credits to the consumer in exchange for the participation of the consumer in the poll or questionnaire.

In another implementation, the system 100 may enable a consumer to receive messages and/or other notifications on a personalized website when new information about a product purchased by the consumer becomes available based on the item-level purchase data associated with the consumer or on items identified in a personal shopping list or basket of goods. Such information may include, for example, safety or recall information regarding the product, upgrade or repair information specific to the product, news articles pertaining to the product, nutritional information regarding food items, possible substitute or compatible products for particular purchased items, and so forth. Such information may be provided from manufacturers or retailers of the product, or from other sources. Additionally, the consumer may receive such information via the system 100 regardless of whether the consumer has registered the product with the manufacturer.

In another embodiment, the system 100 may compile item-level inventory data corresponding to each user or consumer and generate user-specific spending profiles that allow manufacturers and retailers to determine, for example, what products individual consumers typically buy, when and where the consumer buy those products, the frequency at which the consumers by the products, how much the consumers have paid for those products, how far the consumers have traveled to acquire those products, and whether the consumers bought the products online or offline. In some examples, the system 100 may also employ the inventory data to determine how price-sensitive or discount-sensitive the consumers are in response to changing the composition of purchased products based on coupons and other promotional offers.

The system 100 may also compile inventory data from users and aggregate this data to allow manufacturers and retailers to analyze spending habits and purchase trends across designated sub-groups, such as, for example, existing customers, target customers, customers of specific competitors, and customers within a particular geographic distance of particular retail stores.

In another embodiment, the system 100 may enable manufacturers and retailers to determine what prices competitors, such as online competitors, offline competitors, or competitors within some given geographic area, are charging for specific products that they manufacture or sell, or for products that closely resemble products in their own inventory.

The system 100 may also allow manufacturers and retailers to bid on a virtual basket of goods that a consumer is poised to purchase. Through this reverse auction process, the system 100 may permit manufacturers and retailers to persuade new customers to try their brands, enter their stores for the first time, and/or continue shopping in their stores.

In other examples, the system 100 may enable manufacturers and retailers to measure the success of their promotional offers. For example, manufacturers and retailer may analyze the various item-level purchase data to determine what percentage of consumers assemble their shopping lists based on goods that are on sale, how deeply a new product must be discounted in order to entice a consumer to add the product to the virtual basket of the consumer, and what items a consumer purchases after arriving in the store that were not original on the shopping list or in the virtual basket.

In another embodiment, the system 100 may provide manufacturers and retailers the ability to gauge which products consumers are buying online versus offline, and how consumers balance their desire for more convenient methods of purchasing goods against their desire for lower prices or their need to see and feel goods before purchasing them.

In some instances, the system 100 may compile and aggregate the consumer item-level purchase data to generate a consumer sentiment index that can be used to gauge the level of economic activity and predict future consumer purchasing trends and similar data related to a particular market or geographical area.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method comprising:
aggregating item-level purchase data for each of a plurality of users from multiple sources;
receiving offer data from offer providers;
selecting, using at least one processor of a machine, at least one user of the plurality of users to receive an offer based on the item-level purchase data and the offer data; and
transmitting the offer to a communication device of the at least one user.

2. The method of claim 1, the aggregating of the item-level purchase data comprising:
creating an image of a physical retail receipt;
performing optical character recognition on the image of the physical retail receipt to generate character data; and
extracting item-level purchase data from the character data that is generated from the physical retail receipt.

3. The method of claim 1, the aggregating of the item-level purchase data further comprising:
receiving at least a portion of the item-level purchase data that has been manually entered by a consumer.

4. The method of claim 1, the aggregating of the item-level purchase data comprising:
obtaining electronic purchase information generated by a retailer, the electronic purchase information corresponding to one of the plurality of users.

5. The method of claim 4, the obtaining of the electronic purchase information comprising:
collecting the electronic purchase information from a computing device of the one of the plurality of users.

6. The method of claim 4, the obtaining of the electronic purchase information comprising:
collecting the electronic purchase information from an external electronic repository.

7. The method of claim 4, the obtaining of the electronic purchase information comprising:
collecting the electronic purchase information from a third party via an electronic interface.

8. The method of claim 7, wherein the electronic interface comprises an application programming interface.

9. The method of claim 7, wherein the electronic interface comprises a consumer-accessible website, the collecting of the electronic purchase information comprising accessing the website using a data access application to retrieve the electronic purchase information.

10. The method of claim 1, the aggregating of the item-level purchase data comprising:
receiving consent from one of the plurality of users to collect item-level purchase data for the one of the plurality of users.

11. The method of claim 1, the aggregating of the item-level purchase data comprising:
receiving access information from one of the plurality of users, the access information required to access item-level purchase data of the one of the plurality of users that is stored by a third party; and
obtaining the item-level purchase data of the one of the plurality of users from the third party using the access information.

12. The method of claim 1, the aggregating of the item-level purchase data comprising:
aggregating a portion of the item-level purchase data from a point-of-sale computer system of a retailer.

13. The method of claim 1, the aggregating of the item-level purchase data comprising:
aggregating a portion of the item-level purchase data from a back-end computer system employed by a retailer.

14. The method of claim 1, the aggregating of the item-level purchase data comprising:
aggregating a portion of the item-level purchase data from a financial institution.

15. The method of claim 1, the aggregating of the item-level purchase data comprising:
aggregating a portion of the item-level purchase data from a mobile payment provider.

16. The method of claim 1, the aggregating of the item-level purchase data comprising:
aggregating a portion of the item-level purchase data from an item-level transaction data aggregator.

17. The method of claim 1, further comprising storing representations of at least a portion of the item-level purchase data for subsequent analysis.

18. The method of claim 17, the representations comprising images of physical retail receipts.

19. The method of claim 17, the representations comprising character data generated by optical character recognition performed on images of physical retail receipts.

20. The method of claim 17, the representations comprising item-level purchase data extracted from character data generated by optical character recognition performed on images of physical retail receipts.

21. The method of claim 17, the representations comprising electronic receipts.

22. The method of claim 17, the representations comprising selected information extracted from electronic receipts.

23. The method of claim 17, the representations comprising item-level purchase data extracted from electronic receipts.

24. The method of claim 1, further comprising mapping at least a portion of the item-level purchase data to reference product data.

25. The method of claim 24, the reference product data comprising manufacturer-supplied product data.

26. The method of claim 24, the reference product data comprising retailer-supplied product data.

27. The method of claim 24, the reference product data comprising electronic catalog product data provided by a third-party product data aggregator.

28. The method of claim 24, the reference product data comprising end-user-supplied product data.

29. The method of claim 1, the selecting of the at least one user comprising:
extracting, from the offer data, information identifying products that, when purchased by the at least one user, qualifies the at least one user to receive the offer.

30. The method of claim 1, the selecting of the at least one user comprising:
extracting, from the offer data, information identifying at least one criterion that qualifies the at least one user to receive the offer.

31. The method of claim 30, the at least one criterion comprising a demographic characteristic of the at least one user.

32. The method of claim 30, the at least one criterion comprising a shopping preference of the at least one user.

33. The method of claim 30, the at least one criterion comprising a retail store frequented by the at least one user.

34. The method of claim 30, the at least one criterion comprising an acceptance of a previous offer by the at least one user.

35. The method of claim 30, the at least one criterion comprising a rejection of a previous offer by the at least one user.

36. The method of claim 30, the at least one criterion comprising an intensity of preference of a product by the at least one user.

37. The method of claim 30, the at least one criterion comprising an intensity of preference of a product brand by the at least one user.

38. The method of claim 30, the at least one criterion comprising a level of responsiveness to a product discount by the at least one user.

39. The method of claim 30, the at least one criterion comprising a frequency of purchasing in a defined product category by the at least one user.

40. The method of claim 30, the at least one criterion comprising an amount of money spent on past purchases by the at least one user.

41. The method of claim 30, the at least one criterion comprising a measure of brand loyalty demonstrated by the at least one user.

42. The method of claim 1, the transmitting of the offer comprising:
transmitting the offer to an Internet-aware application accessible to the communication device of the at least one user.

43. The method of claim 42, the communication device comprising a television.

44. The method of claim 1, the transmitting of the offer further comprising:
transmitting the offer to a mobile application executing on the communication device of the at least one user.

45. The method of claim 1, the transmitting of the offer further comprising:
transmitting the offer to a web application executing on the communication device of the at least one user.

46. The method of claim 1, further comprising:
determining, using the item-level purchase data, that the at least one user has completed performance required by the offer; and
depositing credit in an account of the at least one user in response to the completed performance.

47. The method of claim 46, further comprising:
compiling cumulative data on the completed performance required by the offer based at least on data concerning the at least one user; and
transmitting the cumulative data to the offer provider that provided the offer.

48. The method of claim 47, further comprising:
receiving modifications to the offer data from the offer provider that provided the offer, the modification being based on the cumulative data.

49. The method of claim 48, further comprising:
conversion of the credit into at least one of cash and a cash-like instrument.

50. The method of claim 49, the cash-like instrument comprising retail credit.

51. The method of claim 49, the cash-like instrument comprising a charitable donation.

52. The method of claim 49, the cash-like instrument comprising a non-profit donation.

53. The method of claim 49, the cash-like instrument comprising an electronic funds transfer to an account of a financial institution.

54. The method of claim 49, the cash-like instrument comprising a purchase credit for a product.

55. The method of claim 49, the cash-like instrument comprising a credit applied to a gift card.

56. The method of claim 49, the cash-like instrument comprising a currency provided by a manufacturer.

57. The method of claim 49, the cash-like instrument comprising a currency provided by a retailer.

58. The method of claim 1, the receiving of the offer data further comprising:
receiving parameters describing the offer via a web interface.

59. The method of claim 1, the receiving of the offer data comprising:
receiving parameters describing the offer via an application programming interface.

60. The method of claim 1, the receiving of the offer data comprising:
receiving the offer data from an automated system, the offer data having been entered into the automated system via one of a plurality of interfaces, the offer data including one or more offer criteria; and
transmitting the offer data to a storage system for subsequent processing.

61. The method of claim 60, the one of the plurality of interfaces comprising a web-based interface.

62. The method of claim 60, the one of the plurality of interfaces comprising a computer application user interface.

63. The method of claim 60, further comprising:
pooling the entered offer data at an offer provider; and
transmitting the pooled offer data for subsequent storage and processing via an application programming interface.

64. The method of claim 60, further comprising:
retrieving previously entered offer data via the one of the plurality of interfaces, the offer transmitted to the communication device of the at least one user being based on the previously entered offer data; and
changing at least a portion of the offer data via the one of the plurality of interfaces.

65. The method of claim 1, the selecting of the at least one user comprising:
matching item-level purchase data of the at least one user with the offer data, the offer data indicating a number of purchases of a product manufactured by the provider of the offer.

66. The method of claim 1, the selecting of the at least one user comprising:
matching item-level purchase data of the at least one user with the offer data, the offer data indicating a number of purchases of a product manufactured by a competitor of the provider of the offer.

67. The method of claim 1, the selecting of the at least one user comprising:
matching item-level purchase data of the at least one user with the offer data, the offer data indicating purchases of a product of the provider of the offer over a specified number of shopping outings.

68. The method of claim 1, the selecting of the at least one user comprising:
matching item-level purchase data for past purchases of the at least one user and demographic information of the at least one user with the offer data.

69. A non-transitory computer-readable storage media comprising instructions that, when executed by at least one processor of a machine, cause the machine to perform operations comprising:
aggregating item-level purchase data for each of a plurality of users from multiple sources;
receiving offer data describing a purchase offer;
selecting at least one user of the plurality of users to receive the purchase offer based on the item-level purchase data and the offer data; and
transmitting the purchase offer to a communication device of the at least one user.

70. A system comprising:
item-level purchase data storage to store item-level purchase data for a plurality of users;
offer data storage to store offer data describing a plurality of purchase offers;
at least one processor; and
at least one memory device storing modules for execution by the at least one processor, the modules comprising:
an offer matching engine to select at least one user of the plurality of users to receive one of the plurality of purchase offers based on the item-level purchase data and the offer data; and
an offer delivery engine to transmit the one of the plurality of purchase offers to a communication device of the at least one user.

71. The system of claim 70, further comprising:
user data storage to store user data describing characteristics of the plurality of users;
the offer matching engine to select the at least one user of the plurality of users to receive the one of the plurality of purchase offers based on the item-level purchase data, the offer data, and the user data.

72. The system of claim 70, the modules further comprising:
a transaction data mapper to map the item-level purchase data of the plurality of users to a standardized format usable by the offer matching engine.
